(19) United States
(12) Patent Application Publication
(10) Pub. No.: US 2011/0253675 A1
(43) Pub. Date: Oct. 20, 2011

(54) Three Phase Vacuum Interrupter Switch for High Voltage Distribution Systems

(75) Inventors: Carl Heller, Brea, CA (US); Kuang-Chien Hu, New Taipei City (TW); Robert Sung, Irvine, CA (US); Patrick Lin, Brea, CA (US)

(73) Assignee: IMPACT POWER, INC., Irvine, CA (US)

(21) Appl. No.: 13/087,321

(22) Filed: Apr. 14, 2011

Related U.S. Application Data
(60) Provisional application No. 61/324,701, filed on Apr. 15, 2010.

(51) Int. Cl. H01H 33/02

(52) U.S. Cl. 218/5

(57) ABSTRACT

A three-phase vacuum interrupter switch assembly for power distribution systems comprises an outer case having at least one window, a plurality of internal disconnect switch assemblies, and a plurality of vacuum interrupter bottle switch assemblies within the case. Each vacuum interrupter bottle switch is coupled in electrical series with a corresponding internal disconnect switch assembly. Because the open/closed state of a bottle switch is not directly observable owing to its sealed interior, a direct visible indication of the state of the three-phase vacuum interrupter switch assembly is provided by a visually detectable contact rod for each internal disconnect switch that is visible through the case window. To prevent potentially serious damage caused by arcing between the contacts of the internal disconnect switch, the internal disconnect switch is prevented from opening or closing when the bottle switches are closed. The case interior is preferably free of oil and/or SF₆ gas.

### FIELD OF THE INVENTION

The present invention pertains to current interrupting switches for power distribution systems. More particularly, the present invention relates to vacuum interrupter switches for underground locations of three-phase four-wire power distribution systems.

### BACKGROUND

Electric utility power distribution systems are frequently constructed underground for a variety of reasons ranging from objections to the above-ground aesthetics, the premium of above-ground space in dense urban locations, and safety concerns. Accordingly, power distribution systems heretofore constructed of poles, wires, and pole-mounted switches and transformers are being superseded and even replaced by underground systems in underground installations.

Whether used in overhead or underground locations within a power distribution system, the main function of current-interrupting switches is to isolate desired sections to allow for maintenance. While overhead space is relatively open and unrestricted, space in underground installations is at a premium. Underground installations (which are also referred to as “vaults”) are relatively small and need to have enough space for all the necessary material, as well as enough room for lineman to safely work inside.

For many vaults, switch installation requires using an equipment access hole which may require lifting a heavy cover and can be costly. A switch that can fit through a maintenance hole (sometimes referred to as an “access hole” or a “manhole”), however, can be very cost effective. Many switches currently used in underground vaults contain oil or SF₆ gas as an electrical insulation medium in order to make the switch small. It is possible that a switch containing oil or SF₆ gas can be made small enough to fit through a maintenance hole; however, rising environmental and safety concerns discourage the use of oil and SF₆ gas, which can each be flammable and/or explosive while presenting environmental hazards when leakage occurs or when emissions are created. Thus, utility companies are trying to move away from switches with oil or SF₆ gas.

Three-phase vacuum switches have been manufactured under the Elastimold trademark by Thomas & Betts Corporation (Memphis, Tenn.) that fit through a maintenance hole, and utilize vacuum interrupter bottle switches as the current-interrupting switch. The vacuum interrupter bottle switches utilized in the Elastimold switches are molded inside a rubber housing and surrounded with a thin metal sheet. Vacuum interrupter bottle switches are manufactured so that the inside components cannot be seen. The only indication as to whether or not the switch is opened or closed is the position of an exterior handle which is not the most direct type of visible evidence one wishes to have when dealing with such high voltages and currents. It is not possible to determine whether the switch is truly open or closed because the movable contacts are hidden inside.

Three-phase vacuum switches have been developed to fit through a maintenance hole, and utilize vacuum interrupter switches as the current-interrupting switch. However, they do not incorporate a visible disconnect switch as a safety feature. It is not possible to determine whether a vacuum interrupter bottle switch is open or closed because the movable contacts associated with the switches are contained within the sealed body of the bottle.

### SUMMARY OF THE INVENTION

The present invention pertains to vacuum interrupter switches designed to replace oil and SF₆ gas switch assemblies, while being compact enough to fit through a 30-inch diameter maintenance hole for use in underground three-phase four-wire power distribution systems.

A vacuum interrupter switch assembly constructed in accordance with the invention (hereinafter sometimes referred to simply as the “switch assembly”) includes a direct visible indication of the vacuum interrupter switch assembly's open-circuited state, a configuration that minimizes the chances of death or injury to personnel and of a spark-induced fire or explosion owing to an attempted connection of the switch assembly to the electrical grid while in an incorrect switching state, and also provides a configuration that can close into and open under a bolted fault current without the container exploding. The term “bolted fault current” is recognized by those skilled in the art to denote the large short circuit current that can flow through the vacuum interrupter switch assembly when conductors at different potentials become connected, the magnitude of which can cause arcing between opening switch contacts.

Other objects, advantages and significant features of the invention will become apparent from the following detailed description, which, taken in conjunction with the annexed drawings, disclose a preferred embodiment of the invention.

It will be understood that orientations described in this specification, such as “up”, “down”, “top”, “side” and the like, are relative, and are used for the purpose of describing an embodiment of the invention with respect to the drawings. Those of ordinary skill in the art will recognize that the orientation of the disclosed device can be varied in practice, and that the orientation used herein has been chosen for explanatory purposes only. Similarly, it will be recognized by those skilled in the art that the materials referred to herein, and particularly those identified by trademark, are examples of materials that meet the requirements and specifications mandated by safety concerns and by the use of the preferred switch assembly with electric power lines. Accordingly, other acceptable materials are within the scope of the invention whether known by generic names and/or other trademarks, or comprising other functionally equivalent material.

### DESCRIPTION OF THE DRAWINGS

FIG. 1 is a left front perspective view of a preferred vacuum interrupter switch assembly constructed in accordance with the invention;

FIG. 2 is a right front perspective view of the vacuum interrupter switch assembly of FIG. 1;

FIG. 3 is a right back perspective view of the vacuum interrupter switch assembly of FIG. 1;

FIG. 4 is a cut-away left side elevation view in schematic of the vacuum interrupter switch assembly of FIG. 1, illustrating the preferred internal layout of the disconnect switch assembly components;

FIG. 5 is a cut-away right side elevation view of the vacuum interrupter switch assembly of FIG. 1, illustrating the internal layout of the vacuum interrupter bottle switch assembly components;

FIG. 6 is a cut-away front elevation view of the vacuum interrupter switch assembly of FIG. 1, illustrating the preferred internal layout of components for the disconnect switch and vacuum interrupter bottle switch assemblies;

FIG. 7 is a side elevation view, in schematic, of a preferred vacuum interrupter bottle switch assembly constructed in accordance with the invention, with its operating mechanism shown in cut-away schematic form;

FIG. 8 is a front partially-sectioned elevation view in schematic of a preferred disconnect switch assembly constructed in accordance with the invention;

FIG. 9 is an exploded right side perspective view of the vacuum interrupter switch assembly of FIG. 1, illustrating the preferred interlocking control assembly;

FIG. 10 is an exploded view of the components fastened to the inside of the cover of the vacuum interrupter switch assembly;

FIG. 11 is a left side elevation view of the preferred components fastened to the bottom of the preferred vacuum interrupter switch assembly;

FIG. 12 is an explosion view of a preferred vacuum interrupter bottle switch assembly without an operating mechanism;

FIG. 13 is an explosion view of the preferred three-phase vacuum interrupter bottle switch assembly without the operating mechanisms;

FIG. 14 is an explosion view illustrating the components of a preferred bus connector;

FIG. 15 illustrates a right front perspective view of the three-phase vacuum interrupter bottle switch assembly of FIG. 5;

FIG. 16 is a left elevation view of the disconnect switch assembly operating mechanism in FIG. 4;

FIG. 17 is a front view of the preferred disconnect switch assembly operating mechanism shown in cut-away schematic form and constructed in accordance with the invention;

FIGS. 18A-T are illustrations of components of the disconnect switch assembly operating mechanism of FIG. 16;

FIG. 19 is a front view of the drive shaft for the disconnect switch assembly;

FIG. 20 is a side view of FIG. 19;

FIG. 21 is a right front perspective of the vacuum interrupter switch assembly with the front and right side panels removed;

FIG. 22 illustrates an explosion view of the preferred disconnect switch insulating shield with bottom contact and connection bus;

FIG. 23 is a cut-away top view of the preferred vacuum interrupter switch assembly illustrating the preferred internal layout of the disconnect switch assembly components;

FIG. 24 is a lower right side perspective view of the preferred vacuum interrupter switch assembly illustrating the preferred internal layout of components;

FIG. 25 is an expanded view of the preferred interlocking control assembly;

FIG. 26 is a cut-away view of the preferred interlocking control assembly illustrating the preferred internal layout of some components.

FIG. 27 is a side view of the preferred operating mechanism assembly for the preferred vacuum interrupter bottle switch assembly;

FIG. 28 is a front view of the operating mechanism assembly of FIG. 27;

FIG. 29 is an internal view of the operating mechanism assembly of FIG. 27;

FIG. 30 is a side view of a preferred spring support rod;

FIG. 31 is a top view illustration of the spring support rod of FIG. 30

FIG. 32 is a side view illustration of the preferred push-pull assembly of FIG. 27;

FIG. 33 is a front view illustration of the push-pull assembly of FIG. 32;

FIG. 34 is a side view of preferred operating shaft for the vacuum interrupter bottle assembly;

FIG. 35 is a front view illustration of the preferred drive shaft assembly of FIG. 27;

FIG. 36 is a front view illustration of the preferred damper assembly of FIG. 27:

FIGS. 37A-Q are illustrations of components of the vacuum interrupter bottle switch assembly operating mechanism of FIG. 27;

FIGS. 38A-H are illustrations of components of the vacuum interrupter bottle switch assembly operating mechanism of FIG. 27;

FIGS. 39A-N are illustrations of components of the vacuum interrupter bottle switch assembly operating mechanism of FIG. 27;

FIG. 40A-D are illustrations of components of the vacuum interrupter bottle switch assembly operating mechanism of FIG. 27;

FIG. 41 is a right side cut-away view of FIG. 35.

FIG. 42 is a front elevation view of a preferred mounting frame;

FIG. 43 is a side elevation view of FIG. 42;

FIG. 44 is a top plan view of a preferred operating handle;

FIG. 45 is a front elevation view of the handle of FIG. 44;

FIG. 46 is a side elevation view of the handle of FIG. 44.

### DETAILED DESCRIPTION OF THE PREFERRED EMBODIMENT

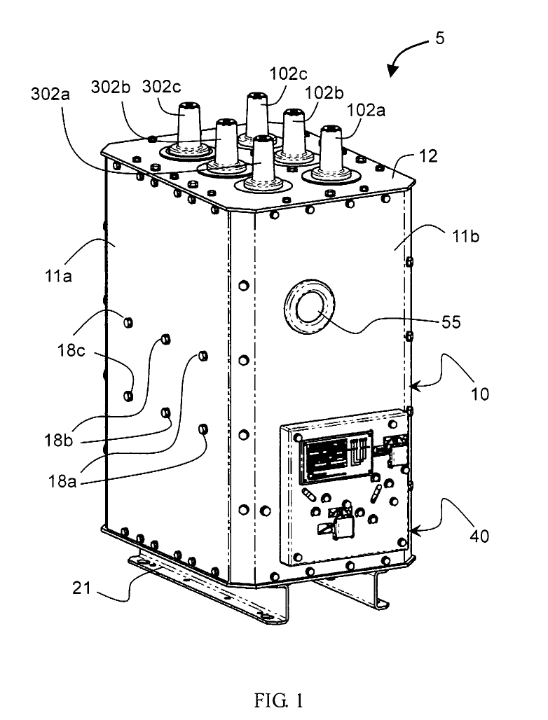

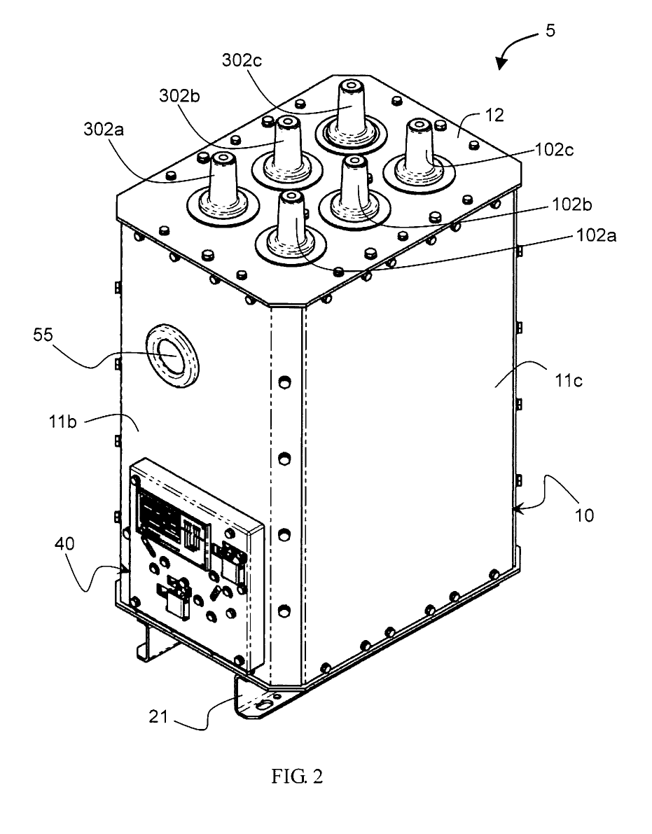

Referring to FIGS. 1-3, a preferred three-phase, two-way, submersible loadbreak vacuum interrupter switch assembly 5 constructed in accordance with the invention is illustrated. The assembly comprises of an outer case 10, formed from a sturdy, corrosive-resistant material. The preferred material is stainless steel. The dimensions of case 10 are preferably approximately 16.7 inches wide by 39 inches high by 25 inches deep to fit within existing access holes and underground spaces available for switching assemblies. Each switch assembly case 10 is filled with dry air. Neither oil nor SF₆ gas is used. Case 10 preferably has sides 11a-d, bottom 13, and cover 12 welded together along the abutting edges. Front side 11b has viewing window 55 and the back side 11d has viewing window 55. As will become clear later, the viewing window permits personnel to view power interruption switches inside the sealed case in order to determine if the switches are open or closed, with the interior of the case 10 being illuminated through the rear window by exterior daylight, a room light, a flashlight, or other source of illumination. It is foreseeable that the vacuum interrupter switch assembly 5 will be placed against a wall, however, rendering the backside window useless, and it may accordingly be desirable to have a second window installed on the front side 11b to enable a flashlight to be shined into the case via the second window while the first front window is used to view the illuminated power interruption switch. Viewing window 55 on the back side can accordingly be moved to the front side, if necessary, or a third window or larger window can simply be used on the front of the illustrated case.

Two sets of three power bushings (302a, 302b, 302c and 102a, 102b, 102c) extend out from cover 12. As illustrated in FIGS. 1-3, power bushings 302a, 302b, and 302c extend from the left region of the cover, while power bushings 102a, 102b, and 102c extend from the right region of the cover. In use, the incoming three-phase power feeder cable is electrically coupled to power bushings 302a, 302b, and 302c. The power bushings 102a, 102b, and 102c are electrically coupled to branch circuits to provide three-phase power. For this invention, the preferred power bushings are manufactured under the Elastimold trademark by Thomas & Betts Corporation (Memphis, Tenn.).

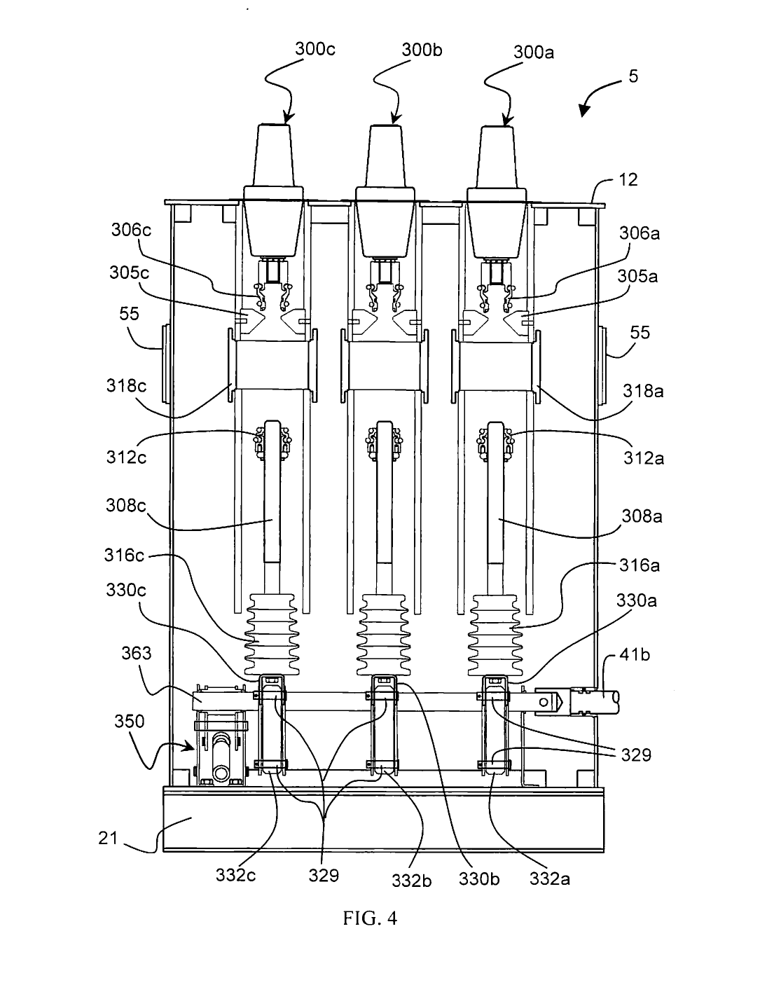

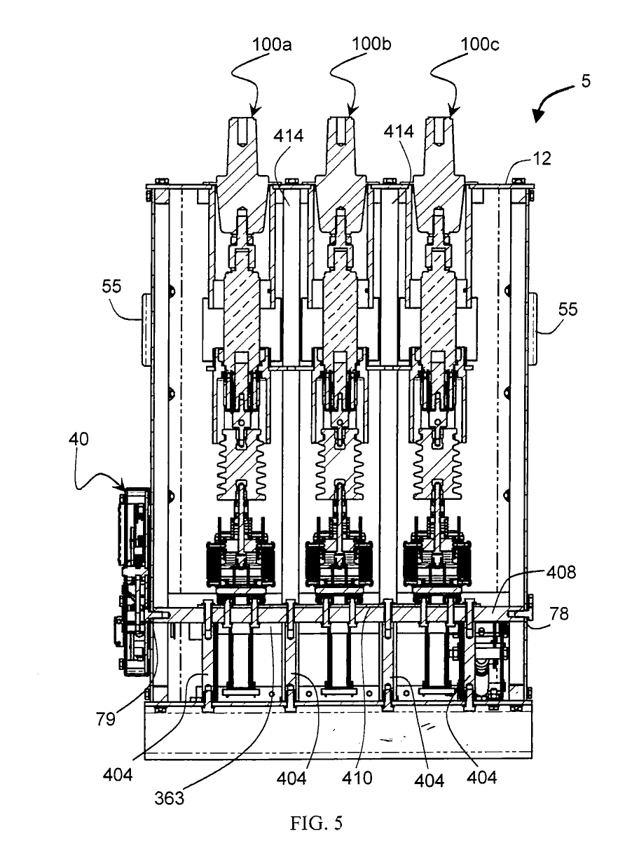

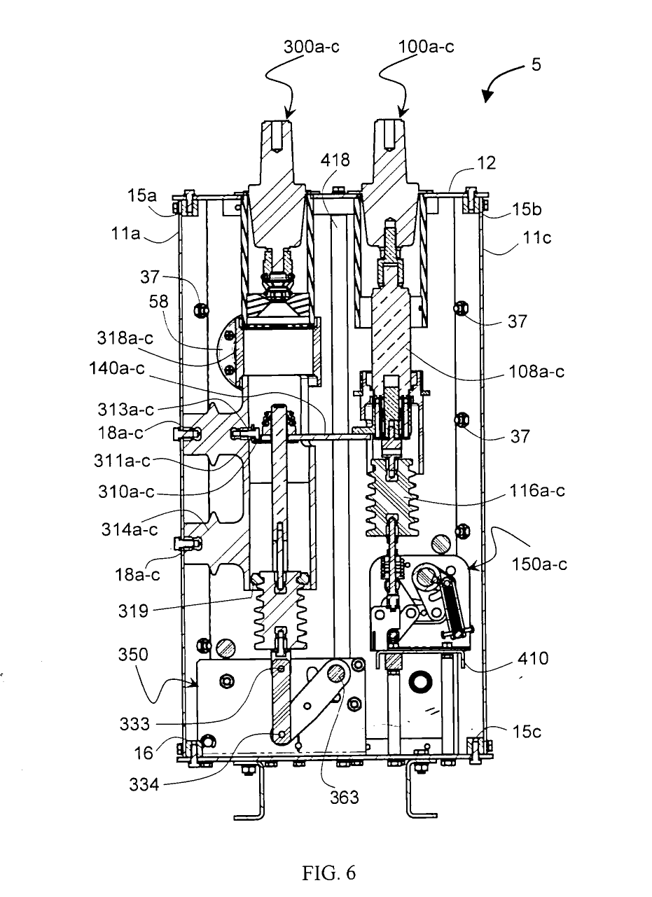

FIG. 4 is a cut-away left side elevation view of the switch assembly 5 illustrating the preferred layout of the assembly's preferred internal disconnect switch assemblies 300a, 300b, and 300c. FIG. 5 is a cut-away right side elevation view of the preferred vacuum interrupter switch assembly 5 illustrating the preferred internal layout of the vacuum interrupter bottle switch assembly components 100a, 100b, and 100c. FIG. 6 is a cut-away front elevation view of the preferred vacuum interrupter switch assembly illustrating the preferred internal layout of the preferred components for the disconnect switch assemblies 300a, 300b, and 300c and vacuum interrupter bottle switch assemblies 100a, 100b, and 100c.

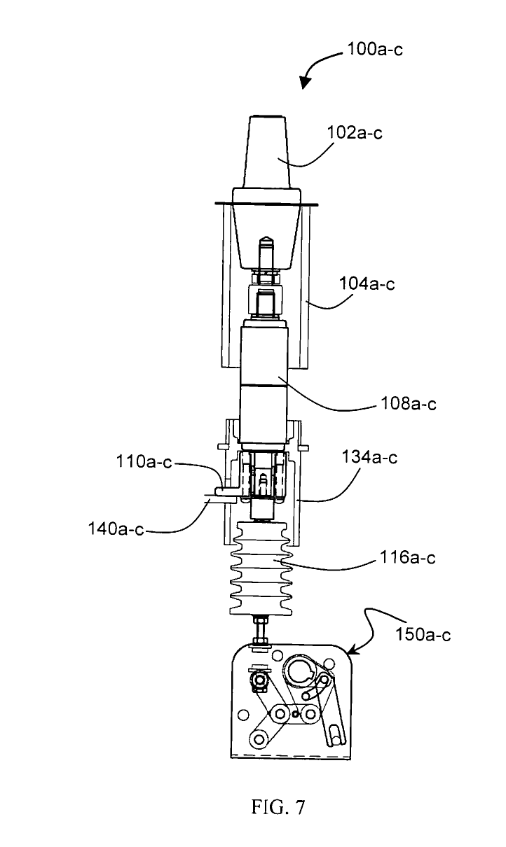

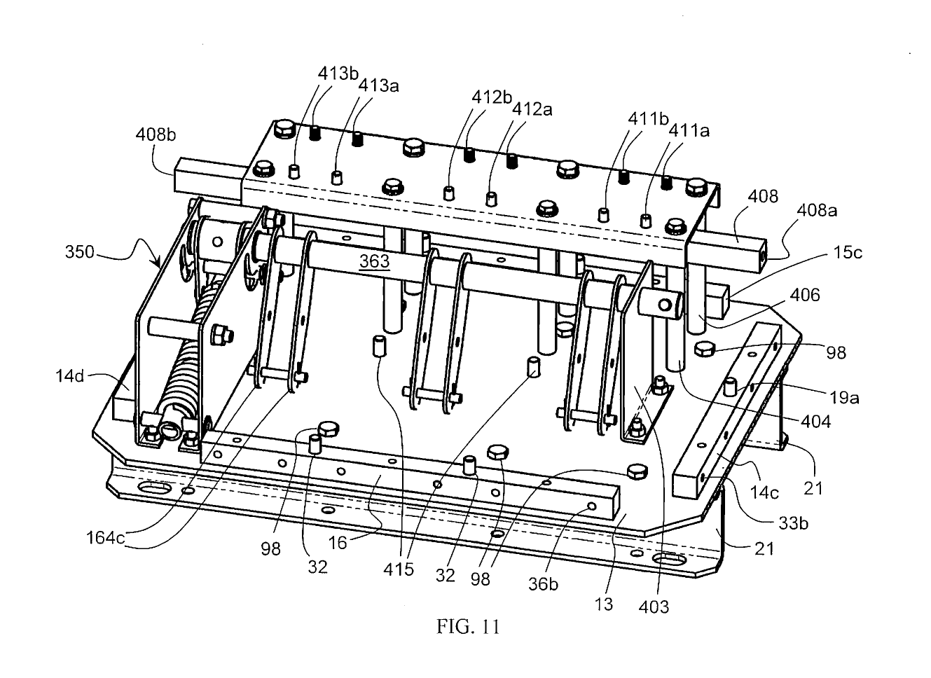

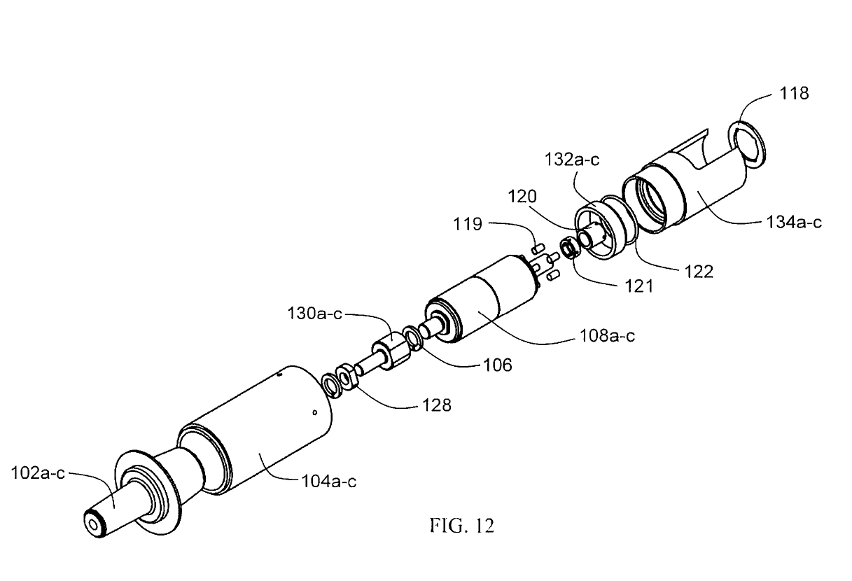

FIG. 7 is a side elevation view, in schematic, of a preferred vacuum interrupter bottle switch assembly constructed in accordance with the invention, with its operating mechanism shown in cut-away schematic form. As illustrated in FIGS. 7 and 12, vacuum interrupter bottle switch assemblies 100a, 100b, and 100c each generally comprise a power bushing 102a-c, an insulation shield 104a-c, a vacuum interrupter bottle switch 108a-c, a common bus connector 110a-c, a push-pull insulator 116a-c, and an operating mechanism assembly 150a-c. For the sake of brevity, it will be understood that a description of a component having an “a” suffix following its reference numeral will also serve as a description of a corresponding component having a “b” or “c” suffix service unless otherwise stated in the specification or as evident from the Figures. Likewise, all three corresponding components may be referred to with the suffix “a-c” following the reference numeral.

As illustrated in FIGS. 5 and 6, vacuum interrupter bottle switch assembly 100a extends vertically upward and out of cover 12. Vacuum interrupter bottle switch assembly 100b extends vertically upward and out of cover 12, behind vacuum interrupter bottle switch assembly 100a and generally parallel thereto. Vacuum interrupter bottle switch assembly 100c extends vertically upward and out of cover 12, behind vacuum interrupter bottle switch assembly 100b and generally parallel thereto.

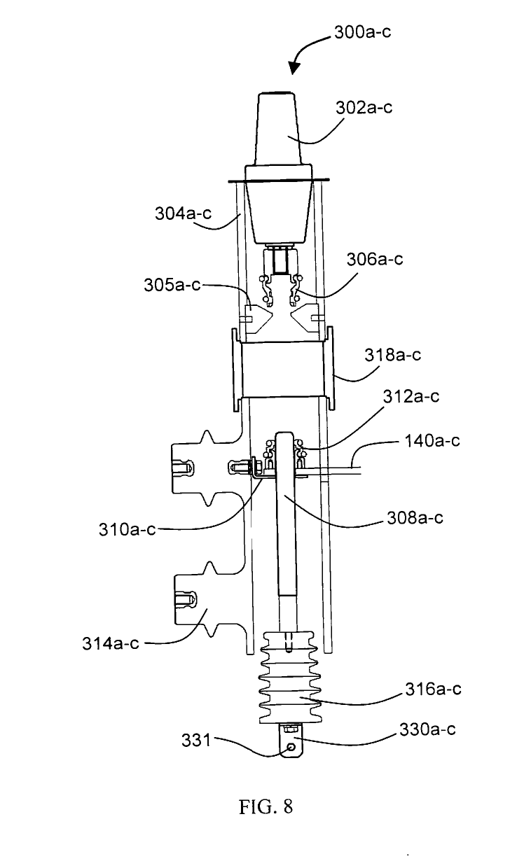

FIG. 8 is a front partially-sectioned elevation view in schematic of a preferred disconnect switch assembly constructed in accordance with the invention. Disconnect switch assemblies 300a, 300b and 300c are all represented in FIG. 8, with the nomenclature 300a-c. Corresponding elements of the respective disconnect switch assemblies are denoted similarly. Disconnect switch assembly 300a-c is generally comprised of a power bushing 302a-c, an insulating shield 304a-c, a transparent insulating shield 318a-c, top contact 306a-c and bottom contact 312a-c, a contact rod 308a-c, an insulating shield 314a-c, and a push-pull insulator 316a-c. As illustrated in FIGS. 4 and 6, internal disconnect switch assembly 300a extends vertically upward and out of cover 12. Internal disconnect switch assembly 300b extends vertically upward and out of cover 12 behind internal disconnect switch assembly 300a and generally parallel thereto. Internal disconnect switch assembly 300c extends vertically upward and out of cover 12 behind internal disconnect switch assembly 300b and generally parallel thereto.

As illustrated in FIG. 6, each vacuum interrupter bottle switch assembly 100a-c is mechanically and electrically coupled to a corresponding disconnect switch assembly 300a-c through bus 140a-c. Bus 140a-c is connected to L-bracket 310a-c (best shown in FIG. 8) of disconnect switch assembly 300a-c and to connector 110a-c (best shown in FIG. 7) of vacuum interrupter bottle switch assembly 100a-c.

As illustrated in FIG. 4, disconnect switch assemblies 300a, 300b, and 300c (shown in the open position) are connected to drive shaft 363 which is mechanically coupled to operating mechanism 350. Coupling to drive shaft 363 allows the disconnect switch assemblies 300a-c to be controlled in unison. Turning drive shaft 363 clockwise will push contact rods 308a-c through guides 305a-c from the shown “open” position into top contacts 306a-c, the “closed” position where upper contacts 306a-c and bottom contacts 312a-c are electrically coupled through contact rods 308a-c. From the closed position, turning drive shaft 363 counter clockwise pulls contact rods 308a-c out from top contacts 306a-c and back down to bottom contacts 312a-c and into the open position.

As illustrated in FIG. 15, vacuum interrupter bottle switch assemblies 100a, 100b, and 100c are mechanically coupled to drive shaft 60 through operating mechanisms 150a, 150b, and 150c, respectively. Coupling to drive shaft 60 allows the vacuum interrupter bottle switch assemblies 100a-c to be controlled in unison. Referring to FIG. 6, the vacuum interrupter bottle switch assemblies 100a-c are seen in the open position. Turning drive shaft 60 clockwise results in pushing up the moveable contact of vacuum interrupter bottle switch 108a-c such that the internal contacts are pushed together. This is the closed position for the vacuum interrupter bottle switch assembly. From the closed position, turning drive shaft 60 counterclockwise pulls the moveable contact of vacuum interrupter bottle switch 108a-c downwards so that the internal contacts are pulled apart and into the open position.

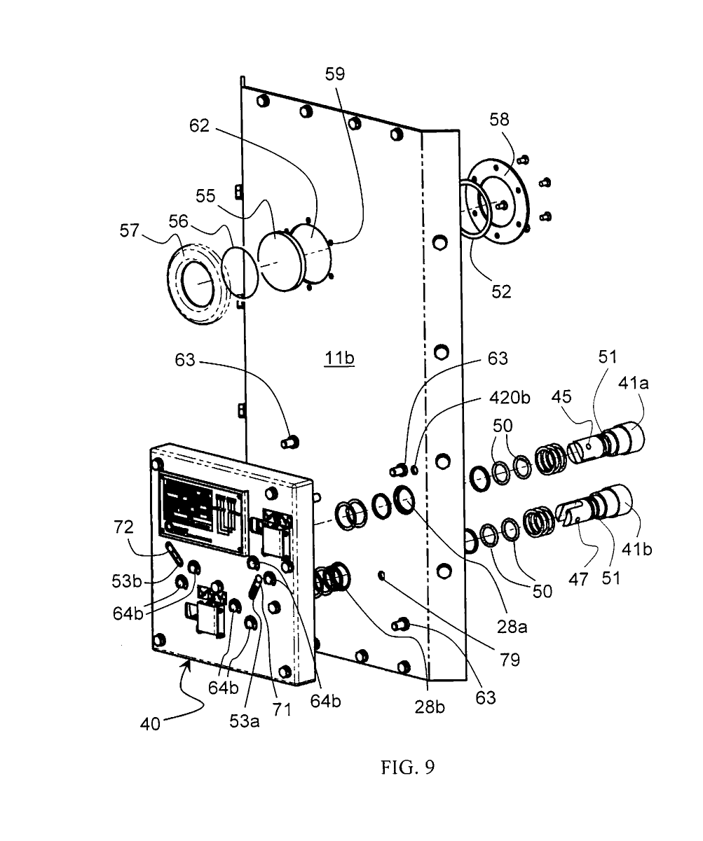

FIG. 9 is an exploded right side perspective view of the vacuum interrupter switch assembly of FIG. 1, illustrating the preferred interlocking control assembly. As illustrated in FIG. 9, interlocking control assembly 40 is preferably affixed to front side 11b. Drive shafts 60 and 363 are mechanically connected to interlocking control assembly 40 via control shafts 41a and 41b, respectively. Interlocking control assembly 40 ensures proper and safe operation of the switch by preventing the internal disconnect switch assemblies 100a-c from opening or closing unless the vacuum interrupter bottle switches 108a-c are open.

If an underground vault has a 30-inch diameter access hole, then switch assembly 5 described above can fit through the hole, bottom side first, and into the vault. If smaller dimensions are desired, then a variety of dielectric materials can be utilized. Oil or SF₆ could also be used, but would re-introduce environmental hazards to the disclosed assembly and negate some of its features and benefits.

A variety of grounding methods are available for the switch assembly 5. One can, for example, weld ground rods to the case 10 so that a grounding wire can be connected to the rods. Alternatively, a bracket can be used so that a grounding wire with a terminal can be bolted on. Once positioned inside the vault, the vacuum interrupter switch can be grounded and synthetic power cables attached to power bushings 102a-c and 302a-c through power cable elbows such as those manufactured under the Elastimold trademark by Thomas & Betts Corporation (Memphis, Tenn.) and under the Cooper trademark by Cooper Power Systems (Waukesha, Wis.). For this invention, Elastimold is the preferred brand.

### Assembly

The assembly of the preferred vacuum interrupter switch assembly will now be discussed. The construction and operation of a vacuum interrupter bottle switches are known to those of ordinary skill in the art, and are not discussed here for the sake of brevity.

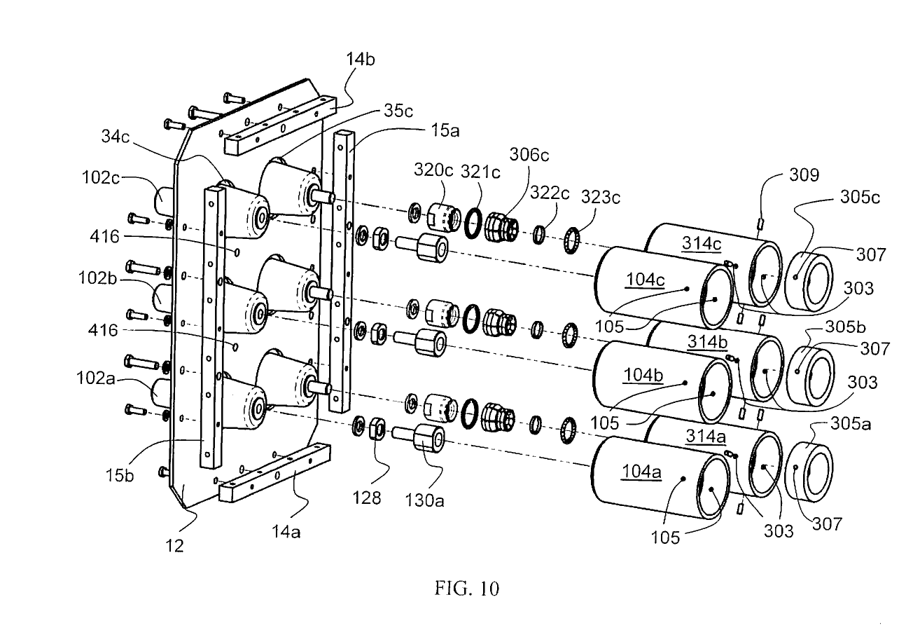

FIG. 10 is an exploded view of the components fastened to the inside of the cover of the vacuum interrupter switch assembly, and FIG. 11 is a left side elevation view of the preferred components fastened to the bottom of the preferred vacuum interrupter switch assembly. Referring to FIGS. 10 and 11, support bars 14a-d, 15a-c, and 16 are bolted into place onto cover 12 and bottom 13 through threaded holes. Floor mounting brackets 21 are fastened with bolts, nuts, and lock washers to the underside of bottom 13 at points 98. Cylindrical support rods 404 and 406 are bolted to bottom 13 through threaded holes. As best illustrated in FIGS. 5 and 11, rectangular support rod 408 is laid on support rods 404. Support stand 410 is laid on rectangular support rod 408 and support rods 406. Support stand 410 is bolted to support rods 406 and, through rectangular support rod 408, to support rods 404.

Power bushing 102a, 102b, and 102c are inserted in respective holes in the cover and welded to cover 12. Power bushing 302a, 302b, and 302c are inserted in respective holes in the cover and welded to cover 12. Nut 128a and a lock washer are installed on the threaded portion of stud adapter 130a which is then threaded into power bushing 102a. Similarly, nuts and lock washers are installed on the threaded portion of stud adapters threaded into power bushing 102b and 102c.

A lock washer and connector 320c are threaded onto the stud of power bushing 302c. The large end of top contact 306c clasps onto the small end of connector 320c. Spring 321c is placed onto top contact 306c to hold it firmly onto connector 320c. Spacer 322c is placed into a small groove inside the small end of top contact 306c. Spring 323c is placed around the small end of top contact 306c. The same is done for the other two power bushings.

As best shown in FIG. 10, the right ends of shields 104a-c have holes 105. The ends of shields 104a-c without the holes 105 are installed onto power bushing 102a, 102b, and 102c, respectively. Similarly, the ends of shields 304a-c without holes 303 are installed onto power bushing 302a, 302b, and 302c, respectively.

Guides 305a-c are each cylindrically-shaped with an interior that is slanted so that one end has a smaller interior cross-section than the other end. Guides 305a, 305b, and 305c are inserted smaller end first into power bushings 302a, 302b, and 302c, respectively. All holes 307 are aligned with holes 303 and inserted with a peg 309.

### Vacuum Interrupter Bottle Switch Assembly 100

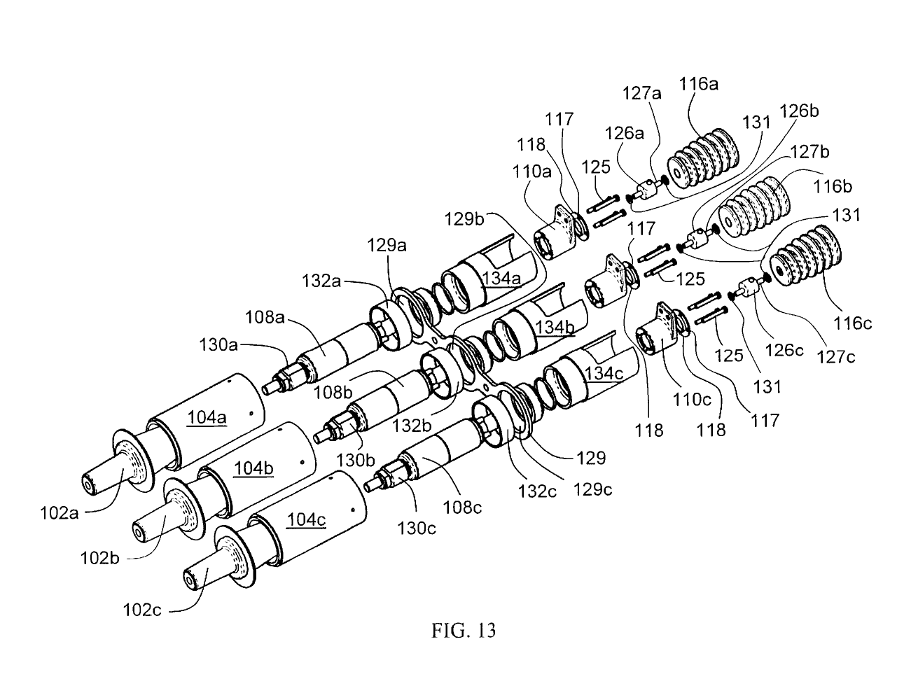

Assembly of the preferred vacuum interrupter bottle switch assembly is best understood with reference to FIGS. 12 and 13. A lock washer 106 is installed onto the stationary contact for vacuum interrupter bottle switches 108a, 108b, and 108c which are then threaded into stud adapters 130a, 130b, and 130c, respectively.

Four insulating cylinders 119 cover the four short studs surrounding the moveable contact of vacuum interrupter bottle switch 108a. A short threaded cylindrical spacer 121 and a long threaded cylindrical spacer 120 are screwed onto the moveable contact for vacuum interrupter bottle switch 108a and tightened against one another. The same is done to vacuum interrupter bottle switches 108b and 108c.

A threaded rod 127a with metal spacer 126a has lock washers 131 placed on both ends and is screwed into the internal threads of the movable contact for vacuum interrupter bottle switch 108a. The same is done to vacuum interrupter bottle switches 108b and 108c.

Insulation cover tops 132a, 132b, and 132c are loosely installed over vacuum interrupter bottle switches 108a, 108b, and 108c, respectively. Assembly holder 129 is loosely installed over vacuum interrupter bottle switches 108a, 108b, and 108c through respective holes 129a, 129b, and 129c. An O-ring 122 is fitted around the movable contact end of vacuum interrupter bottle switches 108a, 108b, and 108c. From openings 135a, 135b, and 135c, insulating covers 134a, 134b, and 134c are fitted over vacuum interrupter bottle switches 132a, 132b, and 132c, respectively.

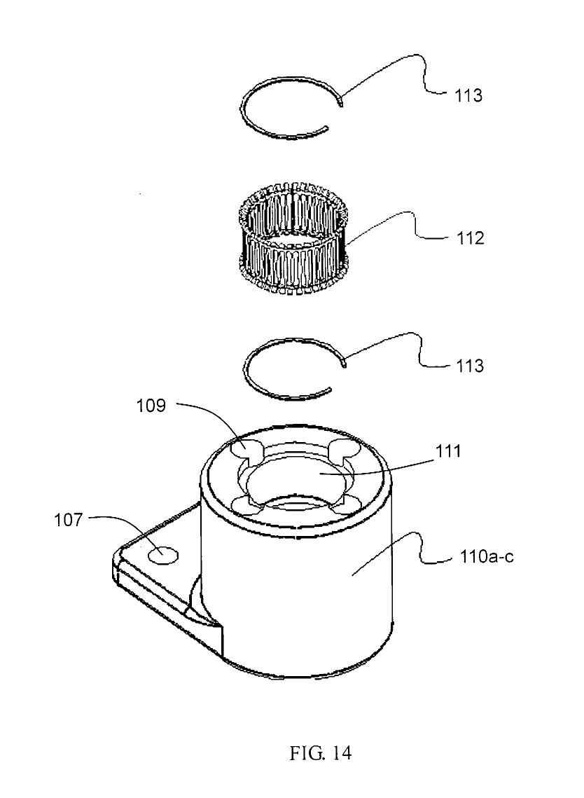

Bus connector 110a-c, as illustrated in FIGS. 13 and 14, comprises a generally cylindrical body with a rectangular flange at one end that has holes 107. The other end of the connector 110a-c has four holes 109 on the other end with internal grooves 111. Within groove 111 is a disposed band of torsion or leaf spring contact material 112. Contact elements of this type are sold, for example, under the Multilam trademark. C-clips 113 secure the Multilam contact 112 within groove 111.

As best illustrated in FIG. 13, bus connector 110a is inserted into insulating cover 134a through the slotted opening end, around metal spacer 126a, and installed onto vacuum interrupter bottle switch 108a by aligning its four holes 109 with the four studs (not shown) surrounding the movable contact of vacuum interrupter bottle switch 108a. An insulating spacer 118 is inserted into bus connector 110a, and around metal spacer 126a, with its holes 117 aligned with holes 109. Four screws 125 are inserted through holes 117 and 109 and screwed into the four studs surrounding the movable contact for vacuum interrupter bottle switch 108a. The same is done with corresponding components to respect to vacuum interrupter bottle switches 108b and 108c.

### Operating Mechanism Assembly 150

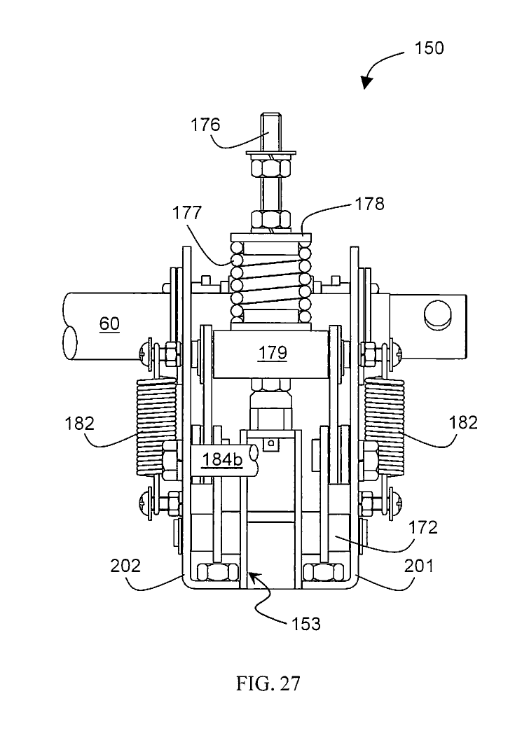

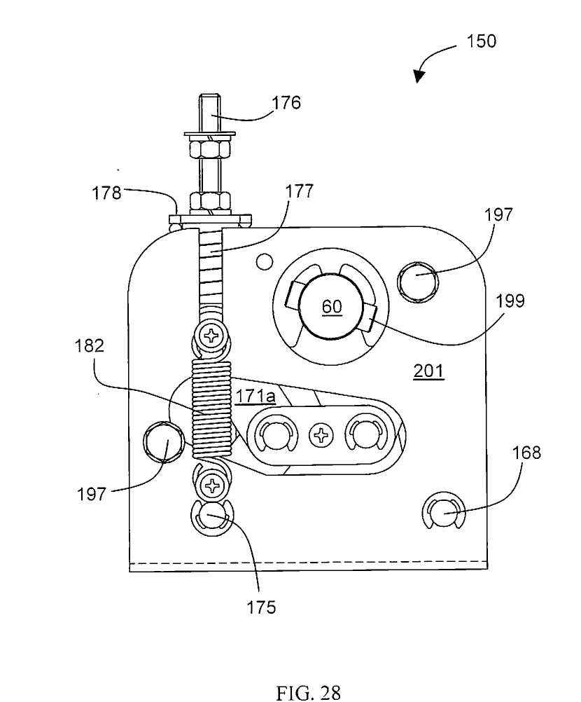

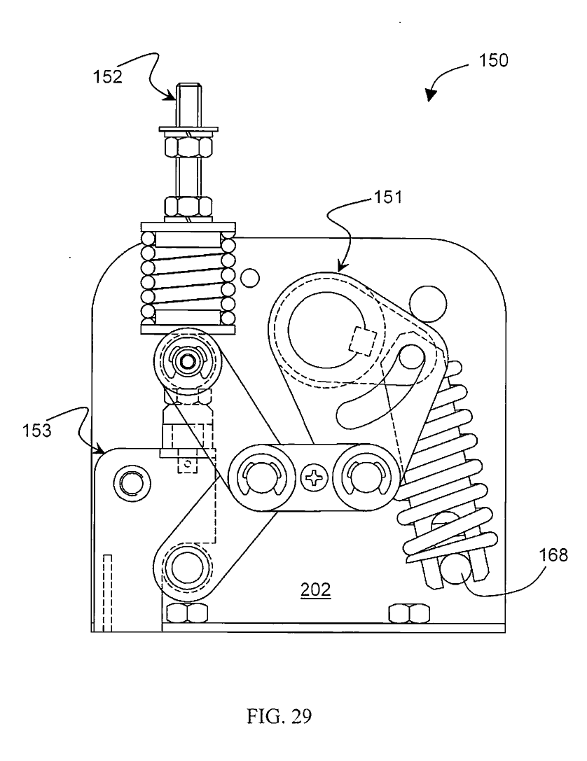

FIGS. 27-28 show right side and front perspective views of a preferred operating mechanism assembly 150 (FIGS. 7, 15) constructed in accordance with the invention. FIG. 29 is an internal view of the operating mechanism assembly 150. The operating mechanism assembly 150 comprises a drive shaft assembly 151, push-pull assembly 152, and damper assembly 153, and framing components. Three identical operating mechanisms are preferably used, and are designated as 150a, 150b, and 150c herein.

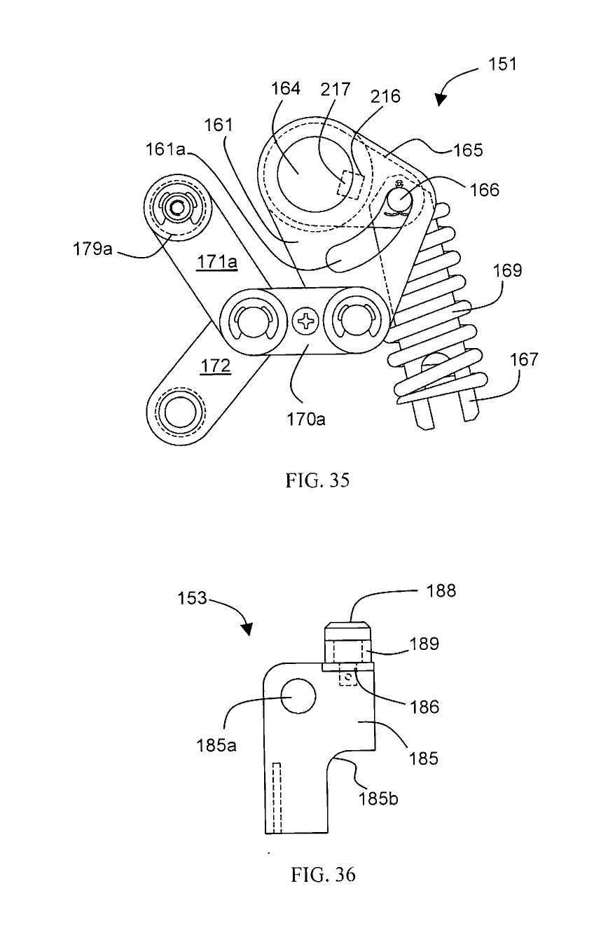

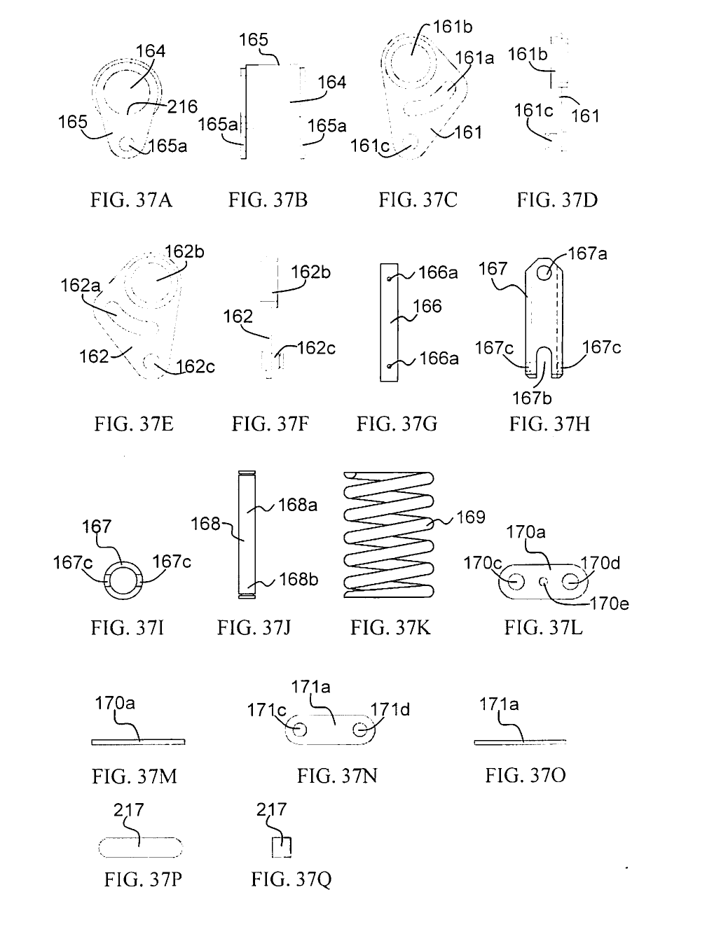

Referring to FIGS. 35, 37A-Q, and 38A-H, the drive shaft assembly 151 is assembled with spring shaft 167 secured between the arms of rotating clevis 165 (FIG. 37B) by inserting pin 166 through holes 165a and hole 167a of spring shaft 167. Spring 169 is slid onto spring shaft 167 and held in place with screws at points 167c. Spring 169 is important since it controls the opening and closing speed of vacuum interrupter bottle switch 108. Pin 166 is held in place with cotter pins inserted into holes 166a. Lever arm 161 is fitted onto rotating clevis 165 with an end of pin 166 inserted into curved slot 161a and shaft opening 161b aligned with shaft opening 164 of rotating clevis 165. Pivot point 161c protrudes away from rotating clevis 165. Lever arm 162 is fitted onto rotating clevis 165 with the other end of pin 166 inserted into curved slot 162a and shaft opening 162b aligned with shaft opening 164 of rotating clevis 165. Pivot point 162c protrudes away from rotating clevis 165.

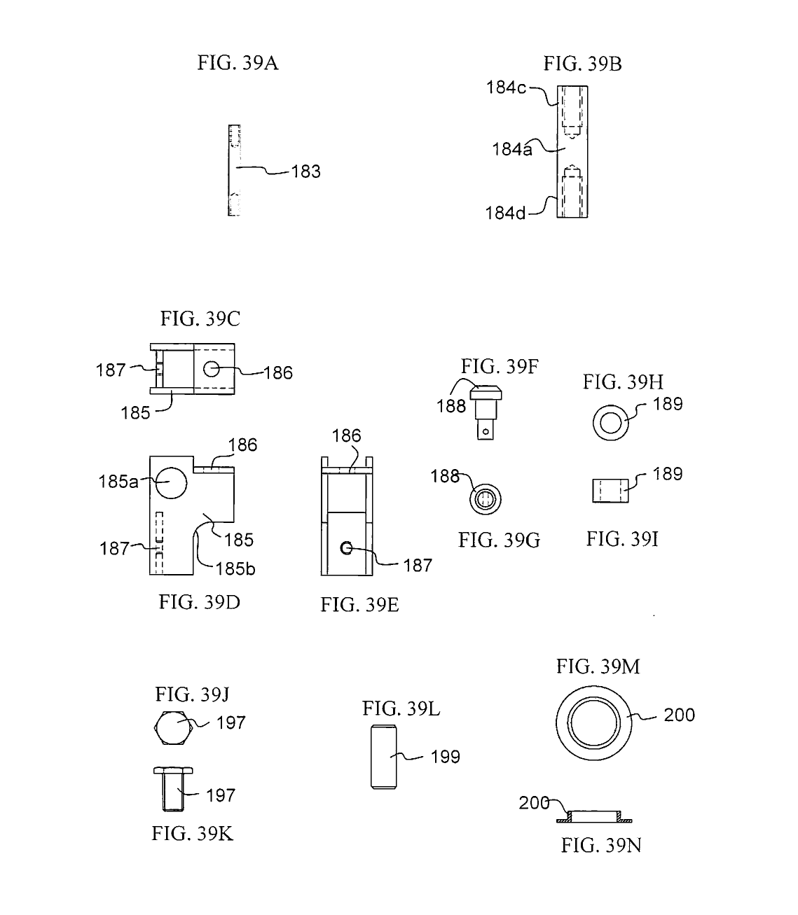

End 170c of toggle link 170a is fastened to pivot point 161c with a retaining washer. End 170d of toggle link 170a along with end 171c of toggle link 171a are fastened by retaining washers to pivot point 173a of clevis 172. Toggle link 170b is substantially identical in structure to toggle link 170a. End 170c of toggle link 170b is fastened to pivot point 162c with a retaining washer. End 170d of toggle link 170b along with end 171d of toggle link 171b is fastened by retaining washers to pivot point 173b of clevis 172. (Note: Toggle link 171b is substantially identical in structure to toggle link 171a (FIGS. 37N,O)). A threaded spacer 183 (FIG. 39A) is fitted between toggle links 170a and 170b and screwed into place at point 170e of both toggle links.

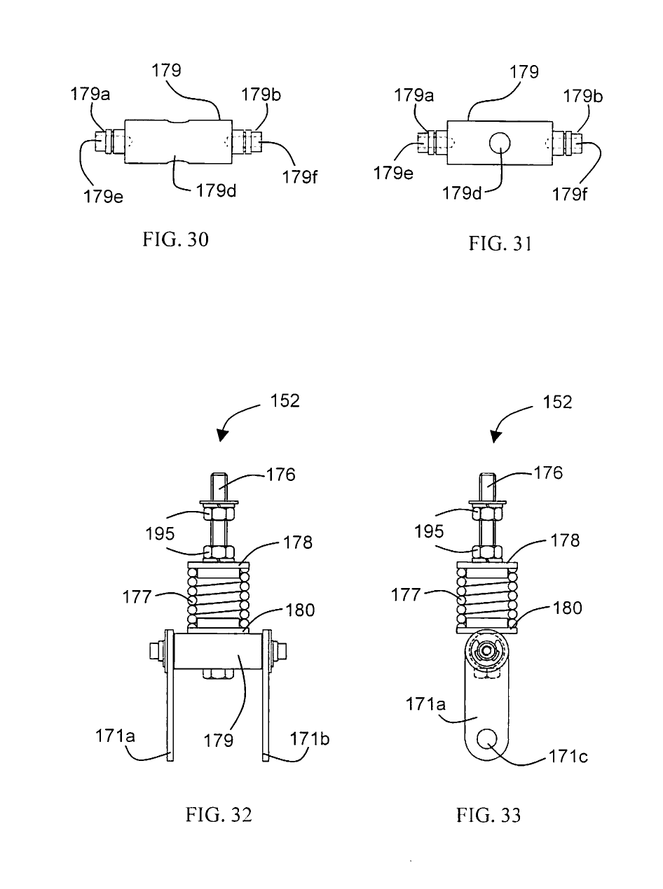

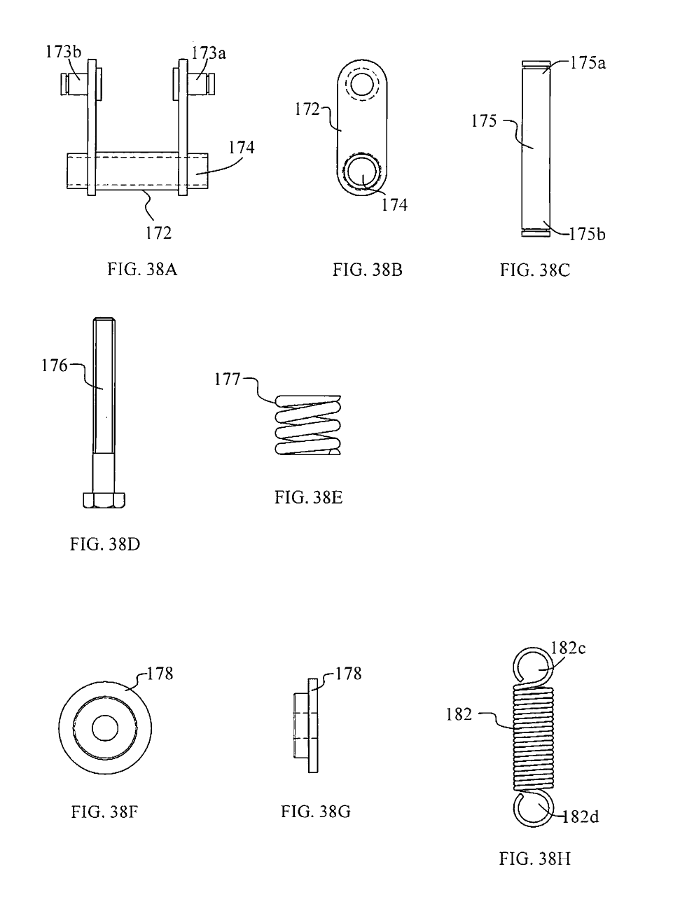

Referring to FIGS. 27-33 and 38A-H, the push-pull assembly 152 is assembled with bolt 176 inserted through hole 179d of spring support rod 179, bottom spring holder 178, over-travel spring 177, and top spring holder 178. A spring washer, two nuts, and a second spring washer are screwed onto bolt 176.

Referring to FIGS. 27, 29, 36 and 39, a damper assembly 153 includes a stopper 188 which is inserted through spacer 189, through hole 186 on support 185 and held in place with a cotter pin.

Drive shaft assembly 151 is connected to push-pull assembly 152 by fastening the end 171d of toggle link 171a to the end 179a of spring support rod 179 with a retaining washer, and fastening the end 171d of the toggle link 171b to the end 179b of spring support rod 179 with a retaining washer. In FIGS. 32 and 33, toggle links 171a-b of drive shaft assembly 151 are shown attached to push-pull assembly 152.

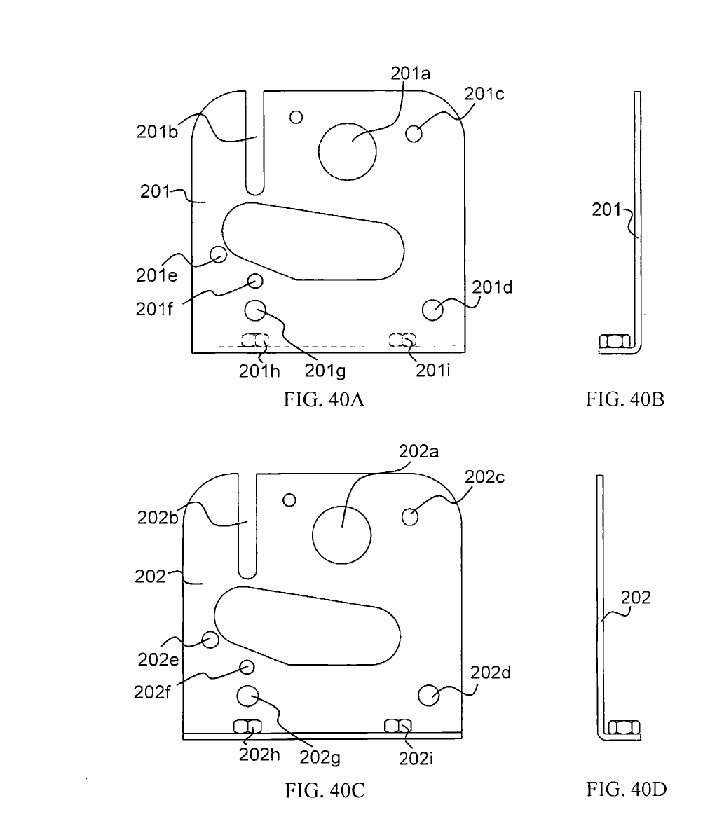

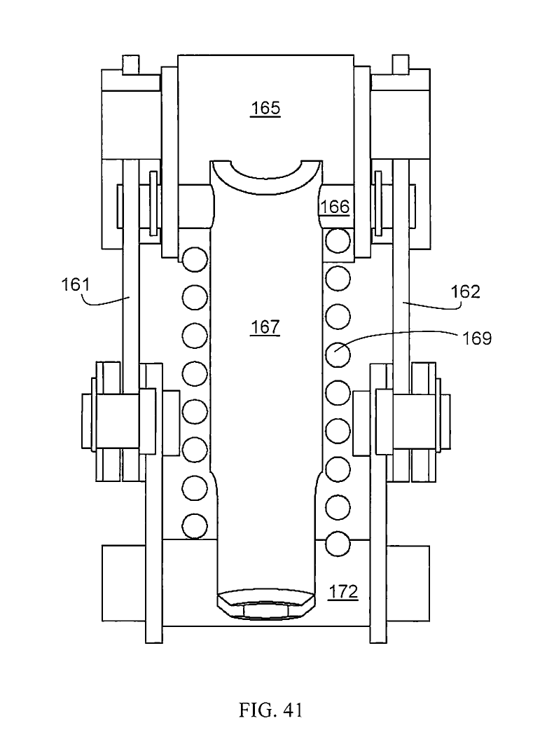

Referring to FIGS. 39 and 40, flanged spacers 200 are inserted into hole 202a on frame 202 and hole 201a on frame 201 from the non-flanged side. Spring support rod end 179b is inserted into slot 202b on frame 202. Bolt 197 is inserted into hole 202c of frame 202 and screwed into threaded spacer 184a at end 184d. A second bolt 197 is inserted into hole 202e of frame 202 and screwed into threaded spacer 184b at end 184d. Pivot rod 175 is inserted into pivot shaft 174 of clevis 172 with end 175b inserted into hole 202g and fastened in place with a retaining washer. Damper assembly 153 is installed onto spacer 184b through hole 185a and positioned between the arms of clevis 172 and on pivot shaft 174 at support point 185b.

Spring support end 179a is inserted into slot 201b on frame 201. A bolt 197 is inserted into hole 201c of frame 201 and screwed into threaded spacer 184a at end 184c. Another bolt 197 is inserted through hole 201e of frame 201 and screwed into threaded spacer 184b at end 184c. End 175a of pivot rod 175 is inserted through hole 201g and fastened into place with a retaining washer. Pin 168 is inserted through hole 202d, slot 167b, and hole 201d and fastened in place with retaining washers. The screws in points 167c are removed.

A support screw is fitted with a flat washer, nut, and spring washer and then screwed into hole 179f at spring support rod end 179b. A support screw is fitted with a flat washer, nut, and spring washer and then screwed into hole 202f of frame 202. Spring end 182c of spring 182 is hooked onto the support screw at support rod end 179b. Spring end 182d of spring 182 is hooked on the support screw at hole 202f of frame 202. A support screw is fitted with a flat washer, nut, and spring washer and then screwed into hole 179e at spring support rod end 179a. A second support screw is fitted with a flat washer, nut, and spring washer and then screwed into hole 201f of frame 201. Spring end 182c of another spring 182 is hooked onto the support screw at support rod end 179a. Spring end 182d of the second spring 182 is hooked on the support screw at hole 201f of frame 201 to complete the assembly of an operating mechanism designated as 150a. Two more operating mechanisms are assembled in the same manner and designated as 150b and 150c.

The small end of push-pull insulator 116a (FIGS. 7, 13) is screwed onto threaded rod 127a (FIG. 13). The large end of push-pull insulator 116a is screwed onto bolt 176a (FIGS. 32, 33) of operating mechanism 150a. The small end of push-pull insulator 116b is screwed onto threaded rod 127b. The large end of push-pull insulator 116b is screwed onto bolt 176b of operating mechanism 150b. The small end of push-pull insulator 116c is screwed onto threaded rod 127c. The large end of push-pull insulator 116c is screwed onto bolt 176c of operating mechanism 150c.

Turning to FIGS. 13 and 15, assembly holder 129 is fitted onto insulating covers 134a, 134b, and 134c through respective holes 129a, 129b, and 129c. Insulation cover tops 132a, 132b, and 132c are fitted onto insulating covers 134a, 134b, and 134c, respectively, with assembly holder 129 held firmly between them.

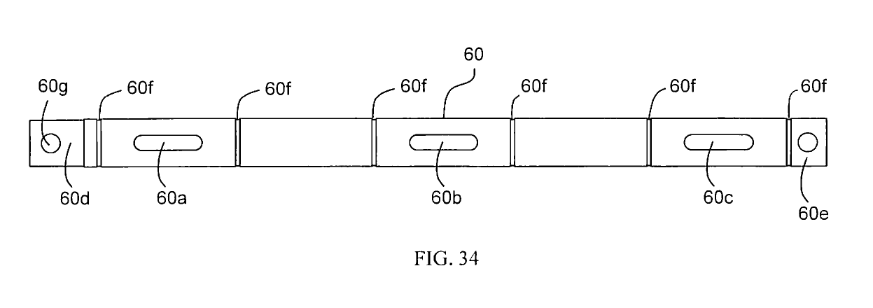

The vacuum interrupter bottle switches 108a-c are mechanically linked together for operation in unison by driveshaft 60. A holding bar 217 is placed in slots 60a, 60b, and 60c of drive shaft 60. End 60d of drive shaft 60 is slid through operating mechanism 150c through its flanged spacer 200 of frame 202. End 60d of drive shaft 60 is then slid through operating mechanism 150b through its flanged spacer 200 of frame 202. End 60d of drive shaft 60 is then slid through operating mechanism 150a through its flanged spacer 200 of frame 202. Operating mechanism 150a is positioned over hole 60a. Operating mechanism 150b is positioned over hole 60b. Operating mechanism 150c is positioned over hole 60c. Drive shaft 60 is rotated until the holding bars 217 in slots 60a, 60b, and 60c fall into notches 216 of each operating mechanism. Drive shaft 60 is held in place with retaining washers at grooves 60f (FIG. 34). A lever rod 199 (FIG. 28) is inserted through drive shaft hole 60g. FIG. 15 best illustrates the assembled three-phase vacuum interrupter bottle switch assemblies 100a, 100b, and 100c.

### Disconnect Switch Assembly 350

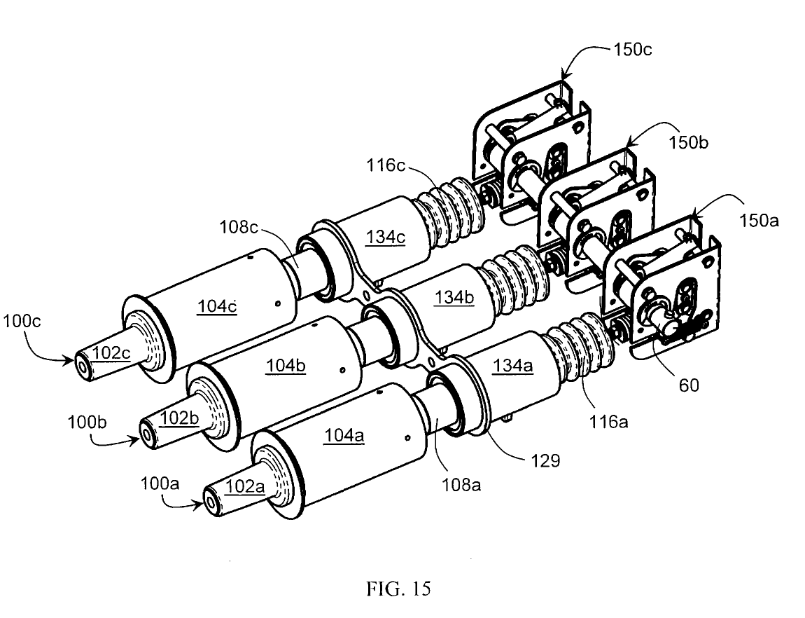

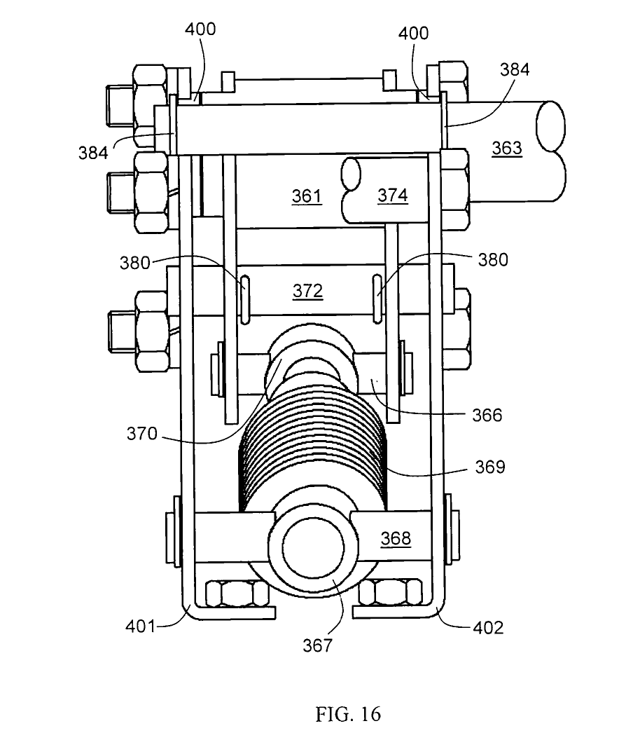

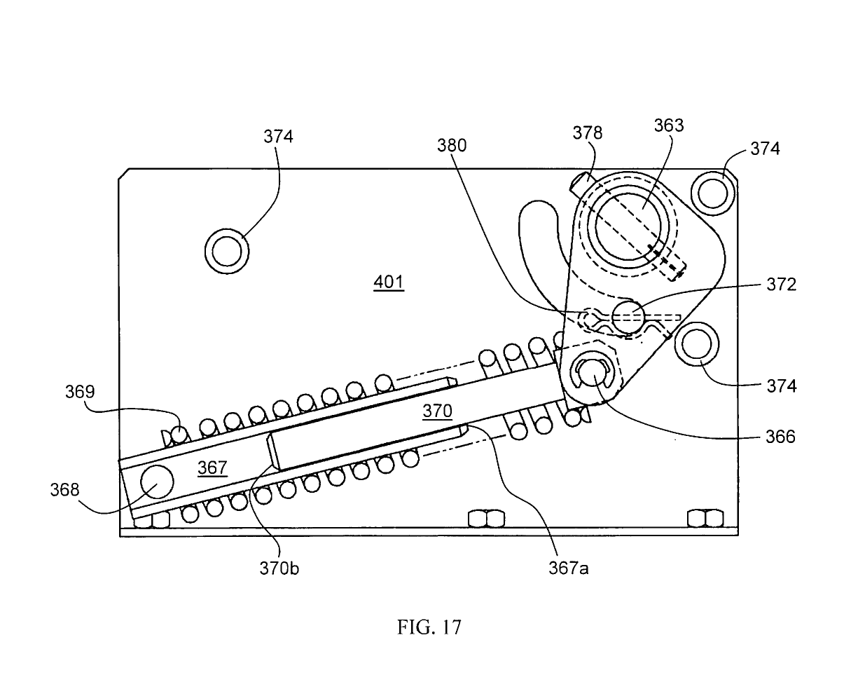

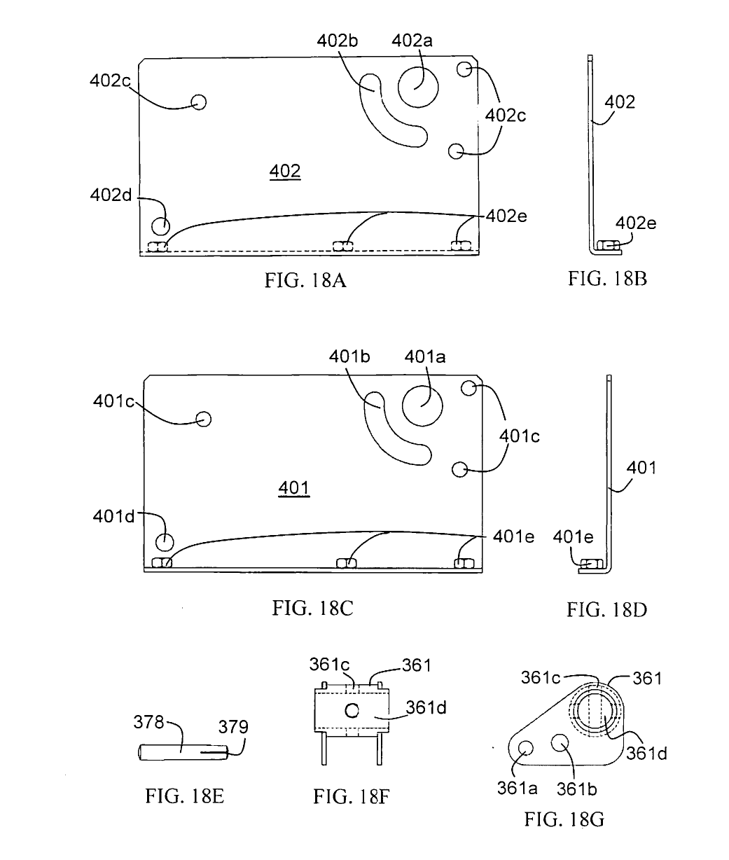

FIG. 16 is a side view of disconnect switch assembly operating mechanism 350. FIG. 17 is an internal view of operating mechanism 350. FIGS. 18a through 18T illustrate the components of the operating mechanism 350. FIGS. 19 and 20 are front and side views, respectively, of disconnect switch assembly drive shaft 363.

As illustrated in FIG. 16, pin 366 (FIG. 18L) is inserted through spring rod hole 370a (FIG. 18N), clevis holes 361a (FIG. 18G), and fastened to clevis 361 with retaining washers 391 at grooves 366a (FIG. 18L). End 370b (FIG. 18N) of spring rod 370 is inserted into spring tube 367 (FIG. 18J) through opening 367a. Spring 369 (FIG. 18Q) is fitted over spring tube 367 and pin 368 (FIG. 18O) is inserted through holes 367b. Pin 368 is inserted into hole 401d of frame 401 (FIGS. 18C,D) and hole 402d of frame 402 (FIGS. 18A,B) and fastened with retaining washers 391 at grooves 368a (FIG. 18O).

Flanged spacers 400 (FIG. 18H) are fitted onto drive shaft 363 (FIG. 19) and at both ends of clevis 361 with the flanged ends butting against the ends of clevis 361. End 400a of flanged spacers 400 (FIG. 18I) is inserted into hole 401a of frame 401 (FIG. 18C) and hole 402a of frame 402 (FIG. 18A). Openings 400c of flanged spacers 400 (FIG. 18H) are aligned with opening 361d of clevis 361 (FIG. 18G). End 363a of drive shaft 363 (FIG. 19) is fitted through retaining ring 384 (FIG. 18J), opening 400c in frame 402 (FIG. 18A), clevis shaft opening 361d of clevis 361 (FIG. 18G) and openings 400c in frame 401 (FIG. 18C) and fastened with retaining rings 384 (FIG. 18J) at grooves 363e (FIG. 19). Holes 361c (FIG. 18F) and hole 363c (FIG. 19) are aligned, and tapered pin 378 (FIG. 18E) is inserted slit end 379 first.

Frames 401 and 402 are held a desired distance apart by spacer tubes 374. The openings of spacer tubes 374 (FIG. 18R) are aligned with holes 401c of frame 401 (FIGS. 18C,D) and holes 402c of frame 402 (FIGS. 18A,B). Bolts are inserted through holes 401c, spacer tubes 374, and 402c and fastened with lock washers and nuts.

Guide rod 372 controls the degree of movement of the clevis 361. Guide rod 372 (FIG. 18S) is inserted through slot 401b of frame 401 (FIG. 18C), holes 361b of clevis 361, and slot 402b of frame 402 (FIG. 18A). Holes 373 of guide rod 372 (FIG. 18S) are positioned between the arms of clevis 361. Straight end 381 of retaining pins 380 (FIG. 18T) are inserted through holes 373 until section 382 of pins 380 surrounds guide rod 372.

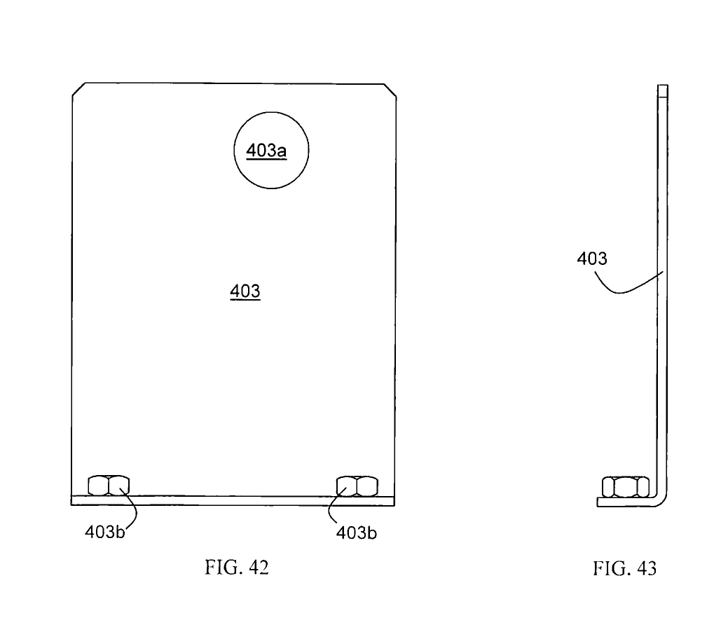

Referring to FIGS. 11, 42, and 43, end 363b of driveshaft 363 is fitted through hole 403a of frame 403 and frames 401, 402, and 403 are fastened to bottom 13 through mounting nuts 401e, 402e, and 403b, respectively.

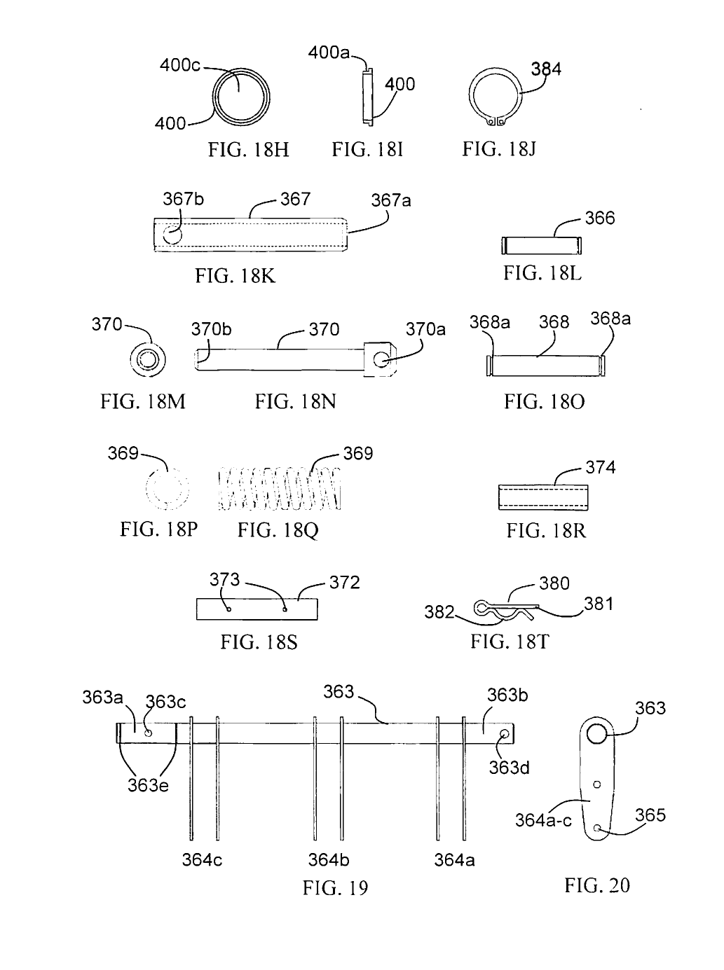

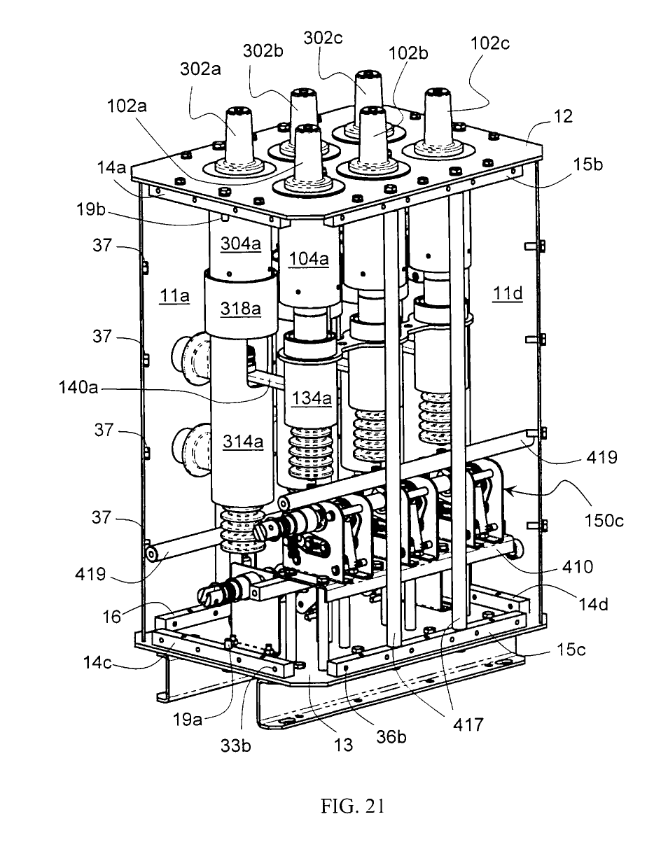

As illustrated in FIGS. 6, 11, 21, 40A, and 40C, each operating mechanism 150a is bolted to support stand 410 through mounting nuts 201h and 201i at points 411a and 202h and 202i at points 411b. Operating mechanism 150b is bolted to support stand 410 through mounting nuts 201h and 201i at points 412a and 202h and 202i at points 412b. Operating mechanism 150c is bolted to support stand 410 through mounting nuts 201h and 201i at points 413a and 202h and 202i at points 413b.

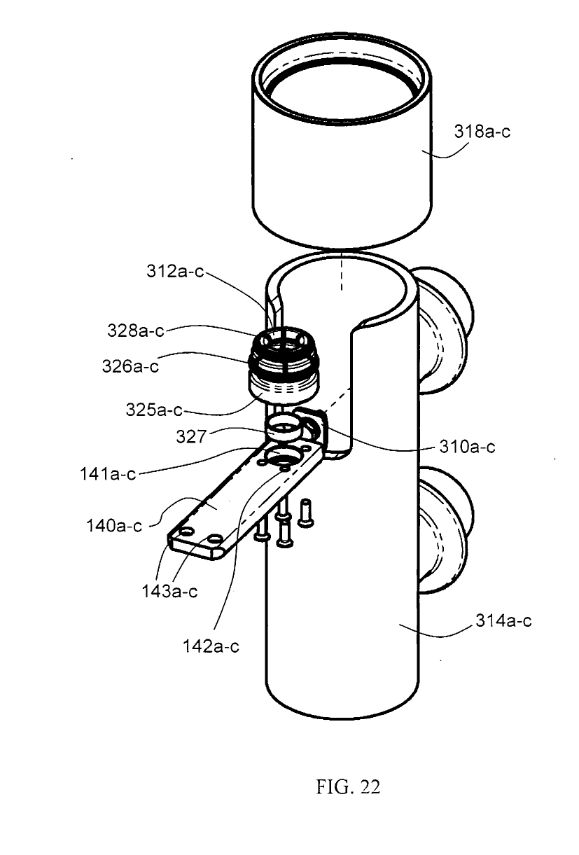

As illustrated in FIGS. 6 and 22, L-bracket 310a is bolted through hole 311a to insulating shield 314a at point 313a. Connector 325a-c are similarly shaped as connector 320a-c, except shorter and wider in diameter. The large end of bottom contact 312a clasps onto the small end of connector 325a. Spring 326 is placed onto bottom contact 312a to hold it firmly onto connector 325a. Spacer 327 is placed into a small groove inside the small end of bottom contact 312a. Spring 328 is placed around the small end of bottom contact 312a. Bolts are inserted through support holes (not shown) in L-bracket 310a through holes 142a of connection bus 140a, and into holes at the bottom of connector 325a. Similarly, L-bracket 310b is bolted through hole 311b to insulating shield 314b at point 313b. The large end of bottom contact 312b clasps onto the small end of connector 325b. Spring 326 is placed onto bottom contact 312b to hold it firmly onto connector 325b. Spacer 327 is placed into a small groove inside the small end of bottom contact 312b. Spring 328 is placed around the small end of bottom contact 312b. Bolts are inserted through support holes (not shown) in L-bracket 310b through holes 142b of connection bus 140b, and into holes at the bottom of connector 325b. Likewise, L-bracket 310c is bolted through hole 311c to insulating shield 314c at point 313c. The large end of bottom contact 312c clasps onto the small end of connector 325c. Spring 326 is placed onto bottom contact 312c to hold it firmly onto connector 325c. Spacer 327 is placed into a small groove inside the small end of bottom contact 312c. Spring 328 is placed around the small end of bottom contact 312c. Bolts are inserted vertically through support holes (not shown) in L-bracket 310c through holes 142c of connection bus 140c, and into holes at the bottom of connector 325c.

As illustrated in FIGS. 4, 6 and 8, a gasket 319 is placed around the small end of each push-pull insulator 316. Contact rod 308a is threaded into the top side of push-pull insulator 316a and clevis-shaped connector 330a is bolted to the bottom side of push-pull insulator 316a. A peg 329 is inserted and fastened to connector 330a and rod 332a through arm holes 331 and 333, respectively. Similarly, contact rod 308b is threaded into the top side of push-pull insulator 316b and clevis-shaped connector 330b is bolted to the bottom side of push-pull insulator 316b. A peg 329 is inserted and fastened to connector 330b and rod 332b through arm holes 331 and 333, respectively. Contact rod 308c is threaded into the top side of push-pull insulator 316c and clevis-shaped connector 330c is bolted to the bottom side of push-pull insulator 316c. A peg 329 is inserted and fastened to connector 330c and rod 332c through arm holes 331 and 333, respectively. Contact rod 308a is inserted into insulating shield 314a and through bottom contact 312a. Contact rod 308b is inserted into bottom contact 312b and insulating shield 314b. Contact rod 308c is inserted into bottom contact 312c.

Referring to FIGS. 6, 21, and 23, tank side 11a is bolted to support bar 15a and to support bar 16. Transparent cylinder 318a is fitted on top of the slotted end for insulating shield 314a. The top end of transparent cylinder 318a is fitted to the bottom end of insulating shield 304a and insulating shield 314a is bolted to tank side 11a at bolting points 18a. Similarly, transparent cylinder 318b is fitted on top of the slotted end for insulating shield 314b. The top end of transparent cylinder 318b is fitted to the bottom end of insulating shield 304b and insulating shield 314b is bolted to tank side 11a behind insulating shield 314a and generally parallel thereto at bolting points 18b. Likewise, transparent cylinder 318c is fitted on top of the slotted end for insulating shield 314c. The top end of transparent cylinder 318c is fitted to the bottom end of insulating shield 304c and insulating shield 314c is bolted to tank side 11a behind insulating shield 314b and generally parallel thereto at bolting points 18c.

As illustrated in FIGS. 4, 6, and 19, a peg 329 is inserted and fastened to rod 332a and drive shaft lever arms 364a through arm holes 334 and 365, respectively. A peg 329 is inserted and fastened to rod 332b and drive shaft lever arms 364b through arm holes 334 and 365, respectively. A peg 329 is inserted and fastened to rod 332c and drive shaft lever arms 364c through arm holes 334 and 365, respectively.

When properly assembled, and as best illustrated in FIGS. 4, 6, and 8, turning drive shaft 363 clockwise will move contact rods 308a-c through bottom contacts 312a-c, up through guide 305a-c and into top contacts 306a-c. This is referred to as the closed position. Top contact 306a will be electrically coupled to bottom contact 312a through contact rod 308a. Top contact 306b will be electrically coupled to bottom contact 312b through contact rod 308b. Top contact 306c will be electrically coupled to bottom contact 312c through contact rod 308c. Contact rods 308a-c can be seen through transparent insulating shields 318a-c and viewing windows 55. From the closed position, turning drive shaft 363 counterclockwise will move contact rods 308a-c out of top contacts 306a-c, through guides 305a-c, and down into bottom contacts 312a-c as illustrated in FIG. 8. This is the open position. Top contacts 306a-c are not electrically coupled to bottom contacts 312a-c and contact rods 308a-c are not visible inside transparent insulating shields 318a-c. As best illustrated in FIG. 6, connection bus 140a is bolted to bus connector 110a (FIG. 13) through holes 143 and holes 107, respectively. Connection bus 140b is bolted to bus connector 110b through holes 143 and holes 107, respectively, behind connection bus 140a and generally parallel thereto. Connection bus 140c is bolted to bus connector 110c through holes 143 and holes 107, respectively, behind connection bus 140b and generally parallel thereto.

Referring to FIGS. 5, 11, 21 and 24, two long cylindrical spacer rods 414 are bolted onto bottom 13 at points 415 and extend vertically upwards to cover 12 where they are bolted at points 416. Two each long cylindrical spacer rods 417 are bolted onto support bars 15c and 16 on bottom 13 and extend vertically upwards to support bars 15a and 15b on cover 12. Two long cylindrical spacer rods 418 are bolted onto support bars 14c and 14d on bottom 13 and extend vertically upwards to support bars 14a and 14b on cover 12.

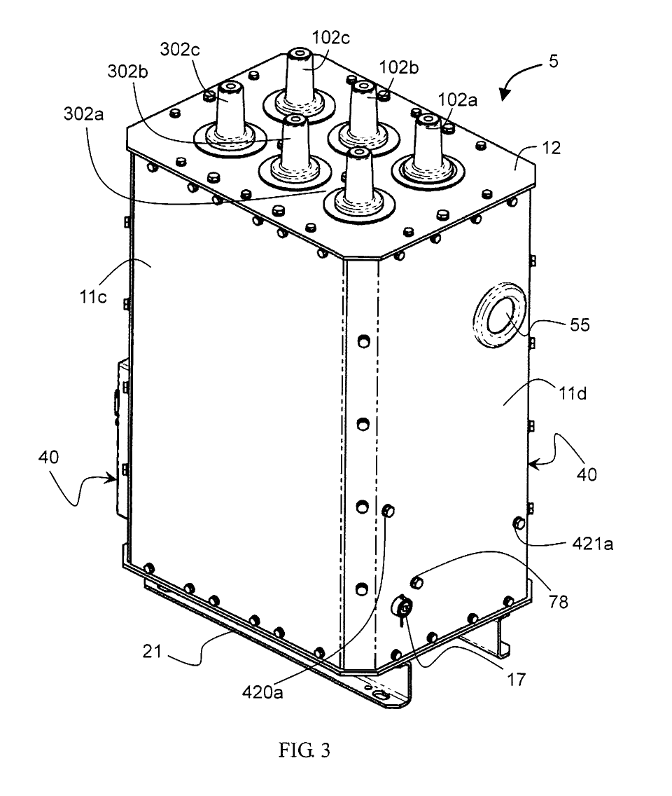

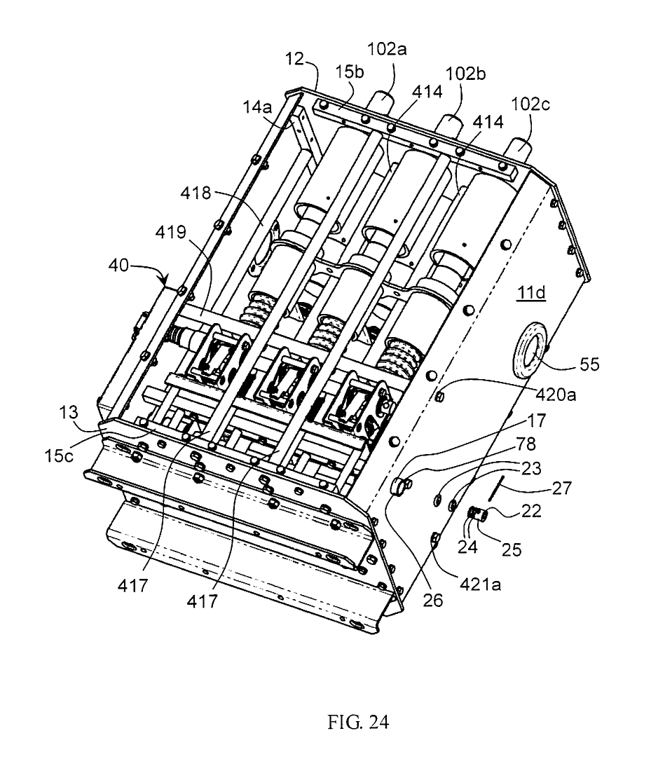

As best illustrated in FIGS. 1, 9, and 23, a rubber cushion 52 is fitted into hole 62 of the tank's front side 11b. A window 55 with an O-ring 56 fitted along the edge is placed over hole 62 of tank side 11b. Window holder 57 is placed over window 55 and O-ring 56 from the outside of tank side 11b and window backplate 58 is placed over hole 62 from the inside of tank side 11b. Window backplate 58 is bolted through holes 58a and 59 to window holder 57 at threaded holes 57a (not shown). The same method is used to place a window 55 onto tank side 11d as shown in FIGS. 3 and 24.

It may now be appreciated that the viewing windows 55 (FIGS. 1-3) allow an operator to look inside vacuum interrupter switch assembly 5 to see whether or not disconnect switch assemblies 300a-c are in the open or closed position. In the closed position, contact rods 308a-c will be seen inside transparent insulating shields 318a-c. In the open position, contact rods 308a-c will not be seen inside transparent insulating shields 318a-c.

As illustrated in FIG. 24, O-rings 23 are fitted into grooves 24 on gas vent plug 22 and inserted into gas vent 17. Holes 26 of gas vent 17 and holes 25 of gas vent plug 22 are aligned and cotter pin 27 is inserted.

### Interlocking Control Assembly 40

Proper integration of a visible disconnect switch should preferably include proper procedures for opening and closing the vacuum interrupter switch assembly. The interlocking control assembly preferably used herein ensures that correct procedures are taken to open and close the vacuum interrupter switch assembly 5. Interlocking control assembly 40 accordingly prevents the internal disconnect switch assemblies 100a-c from opening or closing unless the vacuum interrupter bottle switches 108a-c are open.

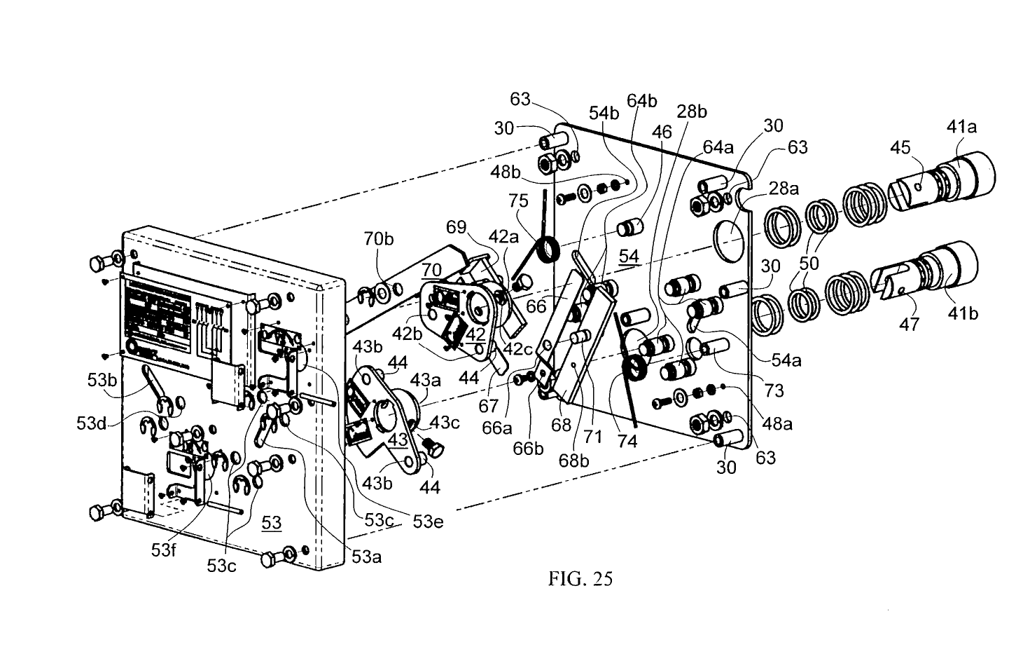

FIG. 25 illustrates an expanded view of the preferred interlocking control assembly 40. Threaded cover spacers 30 and spacer guides 64a and 64b are welded into place on backplate 54. Referring to FIGS. 9, 25, and 26, control assembly backplate 54 is bolted to front side 11b through holes 63 and 31, respectively. O-rings 50 are fitted into grooves 51 of control shafts 41a and 41b. Control arm 42 has studs 44a and 44b inserted in holes 42b. Control arm 43 has studs 44c and 44d inserted in holes 43b.

Referring to FIGS. 1, 2, 9, 23 and 25, the slotted end of control shaft 41a for vacuum interrupter bottle switch assemblies 100a-c is inserted through control shaft well 29a of front side 11b, through hole 28a of backplate 54, and into control arm 42 at opening 42a. Hole 45 of control shaft 41a is aligned with hole 42c of control arm 42 and bolted together. The slotted end of control shaft 41b for disconnect switch assemblies 300a-c is inserted through its control shaft well 29b of front side 11b, through hole 28b of backplate 54, and into control arm 43 at opening 43a. Hole 47 of control shaft 41b is aligned with hole 43c of control arm 43 and bolted together. Spring 74 is placed around threaded spacer 73. Spring 75 is placed around spacer 46.

Rod 71 is inserted through the large hole of blocker guide bar 68 and fastened near the middle with retaining washers. Blocker 66 is screwed to blocker guide bar 68 through holes 66b and 68b, respectively, with rod 71 being inserted through hole 66a of blocker 66.

Pivot rod 72 is inserted through hole 69a of blocker guide bar 69, through slot hole 70b of toggle bar 70, and through hole 67a of blocker 67 and fastened near the middle with retaining washers. A peg 70d is installed into peg hole 70c with peg 70d extending inwards.

Toggle bar 70 is placed onto spacer 46 through pivot hole 70a and fastened with a retaining washer. Guide bar 69 is placed between spacer guides 64b and end 72b of pivot rod 72 is inserted into slot 54b of backplate 54. After installation, the flat portion of control arm 43 will be between blocker 67 and guide bar 69. The back end of rod 71 is inserted into slot 54a of backplate 54 and guide bar 68 is placed between spacer guides 64a. After installation, the flat portion of control arm 42 will be between blocker 66 and guide bar 68.

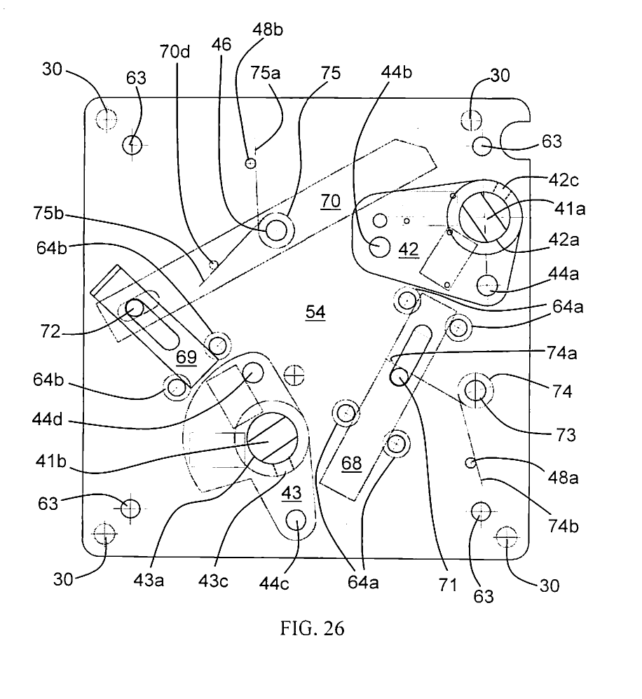

As best illustrated in FIG. 25, a screw and washer is screwed into holes 48a and 48b on backplate 54. As best illustrated in FIG. 26, spring end 74a pushes against rod 71. Spring end 74b pushes against the screw at hole 48a and held down by the washer. Spring end 75a pushes against the screw at hole 48b and held down by the washer. Spring end 75b pushes against peg 70d of toggle bar 70.

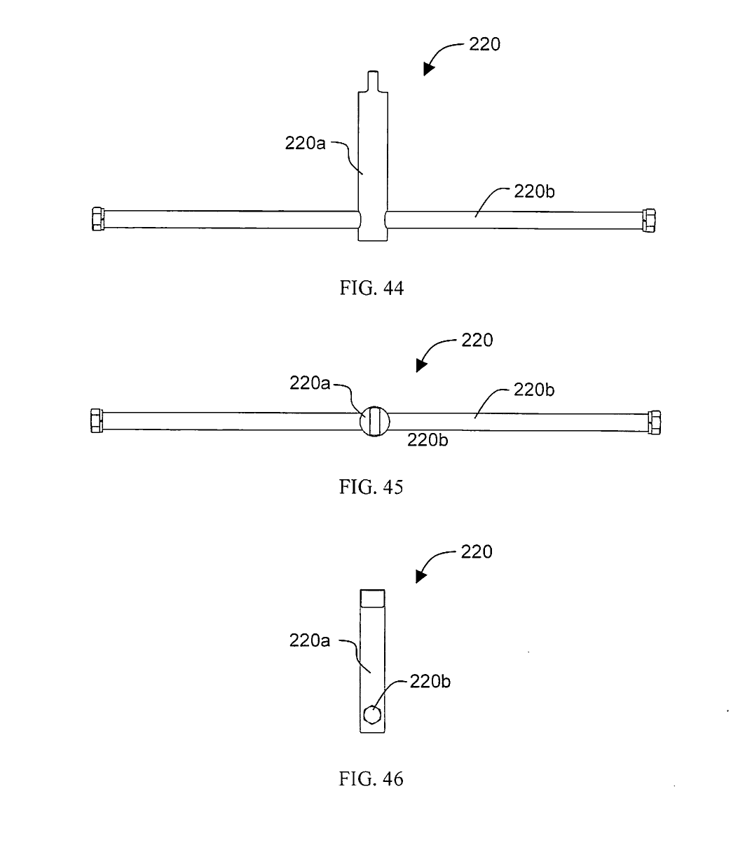

When properly assembled, FIG. 26 illustrates the positions of the interlocking control assembly 40 components when the disconnect switch assemblies 300a-c are in the closed position and the vacuum interrupter bottle switch assemblies 100a-c in the open position. As shown, control arm 42 can only rotate clockwise and control arm 43 can only rotate counterclockwise. When control arm 42 is rotated clockwise, stud 44b will push toggle bar 70 so that it rotates counterclockwise around spacer 46 and pushes guide bar 69 downwards towards control arm 43 guided by spacers 64b. Once the rotation is completed, blocker 67 covers hole 43a of control arm 43 to prevent access with handle 220 (FIG. 44-46). Guide bar 69 is also positioned to prevent control arm 43 from rotating counterclockwise by blocking stud 44d of control arm 43. From this point, control arm 42 must be rotated counterclockwise first before control arm 43 can rotate counterclockwise. After control arm 42 is rotated counterclockwise, spring end 75b pushes against peg 70d so that toggle bar 70 rotates clockwise and guide bar 69 is pulled upwards to allow movement for control arm 43.

When control arm 43 is rotated counterclockwise, stud 44c of control arm 43 will push guide bar 68 upwards towards control arm 42 guided by guide spacers 64a. Once the rotation is completed, blocker 66 covers hole 42a of control arm 42 to prevent access with handle 220. Guide bar 68 is also positioned to prevent control arm 42 from rotating clockwise by blocking stud 44a of control arm 42. From this point, control arm 43 must be rotated clockwise first before control arm 42 can rotate clockwise. After control arm 43 is rotated clockwise, spring end 74a pushes against pivot rod 71 so that guide bar 68 is pulled downwards to allow movement for control arm 42.

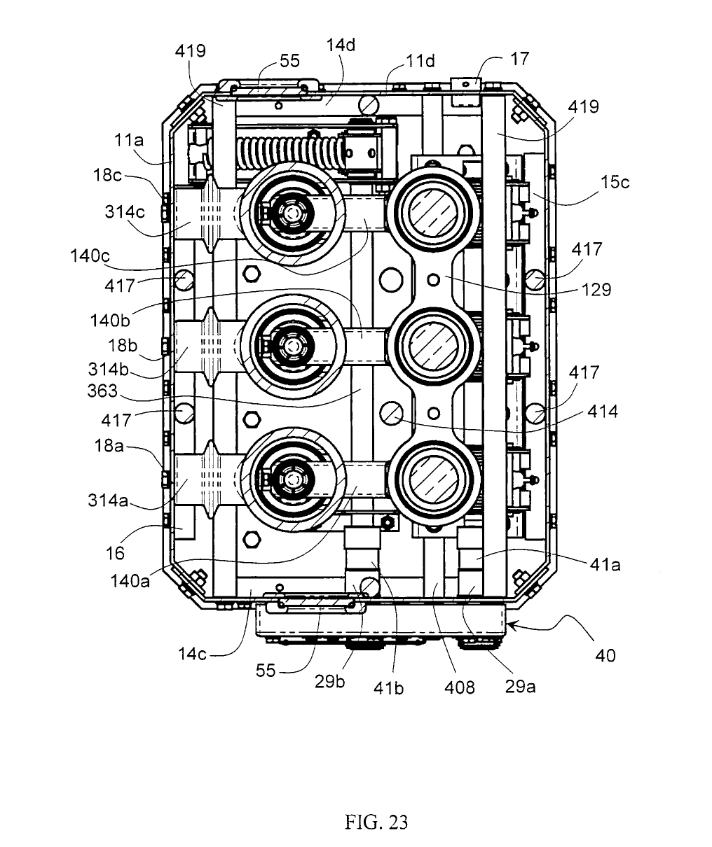

As best illustrated in FIGS. 6 and 23, tank side 11c is bolted to support bars 15b and 15c through threaded holes. Control shafts 41a and 41b are aligned and fitted over ends 60d of drive shaft 60 and end 363b of drive shaft 363, respectively. Tank side 11b is bolted to support bars 14a and 14c through threaded holes. Tank side 11d is bolted to support bars 14b and 14d through threaded holes. Tank sides 11a, 11b, 11c, and 11d are bolted together at bolting nuts 37. As best illustrated in FIG. 5, rectangular support bar 408 is bolted to tank side 11b and 11d at points 79 and 78, respectively. As best illustrated in FIG. 24, cylindrical rods 419 are bolted to tank side 11d at points 420a and 420b and to corresponding points on tank side 11b.

Interlocking control assembly cover 53 is aligned and secured to threaded cover spacers 30 with washers and bolts. As illustrated in FIG. 9, the front end of rod 71 will extend into slot 53a and the front end of pivot rod 72 will extend through slot 53b of cover 53. The front ends of spacer guides 64a and 64b will extend out of holes 53c and 53d, respectively, and fastened with retaining washers. The slotted openings for control shafts 41a and 41b can be accessed through holes 53e and 53f, respectively, of cover 53.

Vacuum interrupter switch 5 is operated with handle 220 (FIGS. 44-46) by inserting the slotted end of handle shaft 220a into the slotted openings of either control shafts 41a or 41b and turning clockwise or counterclockwise.

The specific components illustrated in the drawings and described in the specification are presently preferred components, and there is no intention to limit the scope of the invention to an assembly using these specific components to achieve the intended result. It is recognized that those skilled in the art may be able to change or modify the specifically described hardware, and that various changes, substitutions and alterations can be made herein without departing from the spirit and scope of the invention as defined by appended claims. It is accordingly intended that the claims be interpreted as broadly as possible in light of the prior art, and that the full advantage of the Doctrine of Equivalents be employed in such interpretation.

We claim:

1. A vacuum interrupter switch assembly comprising:
(a) an outer case having at least one window;
(b) a plurality of internal disconnect switch assemblies, each internal disconnect switch assembly including
a power bushing,
first and second electrical contacts spatially separated from each other, one of said contacts being electrically connected to the power bushing, at least a portion of the region between the contacts being viewable through the window
a contact rod movable between the first and second contacts to selectively electrically couple and decouple the first and second contacts,
a visually transparent insulating shield extending along and around at least a portion of the region between the first and second contacts so that the contact rod is sufficiently viewable through the insulating shield and window to visually signify whether the contact rod is electrically coupling or not electrically coupling the first and second contacts,
the control rods of each internal disconnect switch assembly being connected so that the plurality of disconnect switch control rods move in unison;
(c) a plurality of vacuum interrupter bottle switch assemblies, each including
a power bushing,
a substantially stationary electrical contact electrically connected to the power bushing,
a movable electrical contact movable between the first and second positions to selectively electrically couple to and electrically decouple from the substantially stationary contact to thereby respectively close and open-circuit the bottle switch assembly,
the movable electrical contacts of each vacuum interrupter bottle switch assembly being mechanically linked so that the plurality of movable electrical contacts move in unison;
each of the vacuum interrupter bottle switch assemblies being connected in electrical series with a corresponding one of the internal disconnect switch assemblies;
the plurality of vacuum interrupter bottle switch assemblies being mechanically coupled to the plurality of internal disconnect switch assemblies so that electrically coupled disconnect switch contacts cannot become electrically decoupled or become electrically coupled unless the bottle switch contacts are not electrically coupled.

2. The vacuum interrupter switch assembly of claim 1 wherein the case is dimensioned to fit within an access hole of substantially 30 inches in diameter.

3. The vacuum interrupter switch assembly of claim 1 wherein the interior of the case is substantially free of oil and SF₆ gas.

4. The vacuum interrupter switch assembly of claim 1 including
a first shaft coupled to the interrupter bottle switches' movable contacts and having a manually engagable end portion accessible from the exterior of the case for manually electrically coupling and electrically decoupling the interrupter bottle switches' contacts;
a second shaft coupled to internal disconnect switch assembly control rods and having a manually engagable end portion accessible from the exterior of the case for manually electrically coupling and electrically decoupling the first and second contacts of the internal disconnect switch assemblies;
a blocking member coupled to the first shaft, and responsive to the position thereof to block engagement of the second shaft's manually engagable end portion when the interrupter bottle switch assemblies are closed.

5. The vacuum interrupter switch assembly of claim 4 wherein the interior of the case is substantially free of oil and SF₆ gas.

6. The vacuum interrupter switch assembly of claim 5 wherein the case is dimensioned to fit within an access hole of substantially 30 inches in diameter.
